(19) United States
(12) Patent Application Publication
(10) Pub. No.: US 2013/0234530 A1
(43) Pub. Date: Sep. 12, 2013

(54) WIRELESS POWER TRANSFER SYSTEM AND WIRELESS POWER TRANSFER METHOD

(71) Applicant: HITACHI MAXELL, LTD., Osaka (JP)

(72) Inventor: Yasushi MIYAUCHI, Osaka (JP)

(73) Assignee: HITACHI MAXELL, LTD., Osaka (JP)

(21) Appl. No.: 13/785,920

(22) Filed: Mar. 5, 2013

(30) Foreign Application Priority Data
Mar. 7, 2012 (JP) 2012-050764

(51) Int. Cl. H02J 17/00

(52) U.S. Cl. CPC H02J 17/00
USPC 307/104

(57) ABSTRACT

A wireless power transfer system includes a power transmitter including a power transmission resonator composed of a power transmission coil and a resonant capacitance; and a power receiver including a power receiving resonator composed of a power receiving coil and a resonant capacitance. The system further includes a power transmission auxiliary device including an auxiliary resonator composed of an auxiliary coil and a resonant capacitance. The power transmission auxiliary device and the power transmission device oppose each other, forming a power receiving space for placing the power receiving coil between the power transmission coil and the auxiliary coil, and power transfer is performed in the power receiving space while involving a movement of the power receiving coil including at least one of a displacement and a rotation. The power transfer can be performed with stable efficiency in spite of the movement of the power receiver.

### BACKGROUND OF THE INVENTION

1. Field of the Invention

The present invention relates to a wireless power transfer system and a wireless power transfer method for wireless power transfer via a power transmission coil provided in a power transmitter and a power receiving coil provided in a power receiver.

2. Description of Related Art

As wireless power transfer methods, an electromagnetic induction type (several hundred kHz), electric or magnetic-field resonance type using transfer based on LC resonance through electric or magnetic field resonance, a microwave transmission-type using radio waves (several GHz), and a laser transmission-type using electromagnetic waves (light) in the visible radiation range are known. Among them, the electromagnetic induction type has already been used practically. Although this method is advantageous, for example, in that it can be realized with simple circuitry (a transformer), it also has the problem of a short power transmission distance.

Therefore, the electric or magnetic field resonance-type power transfer method, which can provide a short-distance transfer (up to 2 m), has been attracting attention recently. Among them, in the electric field resonance type method, when placing the hand or the like in a transfer path, a dielectric loss is caused, because the human body, which is a dielectric, absorbs energy as heat. In contrast, in the magnetic field resonance type method, the human body hardly absorbs energy and a dielectric loss thus can be avoided. From this viewpoint, the magnetic field resonance type method attracts an increasing attention.

FIG. 20 is a plan view schematically showing an exemplary configuration of a conventional wireless power transfer system using magnetic field resonance. A power transmitter 1 includes a power transmission coil unit including a combination of a loop coil 3a and a power transmission coil 4a (operating as a power transmission resonance coil). A power receiver 2 includes a power receiving coil unit including a combination of a loop coil 3b and a power receiving coil 4b (operating as a power receiving resonance coil). A high frequency power driver 5 is connected to the loop coil 3a of the power transmitter 1. The power of an AC power supply (AC 100 V) 6 is converted into a transmittable high frequency power by the high frequency power driver 5 and is supplied. As a load to the loop coil 3b of the power receiver 2, for example, a rechargeable battery 8 is connected via a rectifier 7.

The loop coil 3a is a dielectric element that is excited by an electric signal supplied from the high frequency power driver 5 and transfers the electric signal to the power transmission coil 4a by electromagnetic induction. The power transmission coil 4a generates a magnetic field based on the electric signal that has been output from the loop coil 3a. The magnetic field strength of the power transmission coil 4a becomes the largest when the resonant frequency f0=1/{2π(LC)^{1/2}} (L represents the inductance of the power transmission coil 4a on the power transmission side, and C represents the stray capacitance). The power supplied to the power transmission coil 4a is wirelessly transferred to the power receiving coil 4b through magnetic field resonance. The transferred power is transferred from the power receiving coil 4b to the loop coil 3b through electromagnetic induction, rectified by the rectifier 7, and supplied to the rechargeable battery 8. In this case, the resonance frequencies of the power transmission coil 4a and the power receiving coil 4b are set to be the same.

JP 2011-109903 A describes one example of wirelessly transferring power to a vehicle on the move by such a magnetic field resonance type method. In the configuration described in JP 2011-109903 A, a power transmission antenna is set to have lengths in a X direction and a Y direction larger than those of a power receiving antenna, and the power receiving antenna is set to have a longer length in the X direction than that in the Y direction, where the Y direction is the traveling direction of the vehicle and the X direction is a direction perpendicular to the traveling direction of the vehicle. This makes it possible to carry out charging/feeding while maintaining stability against misalignments, particularly, lateral misalignments relative to the vehicle traveling direction, which arise during charging to a moving or parked vehicle.

By the technique disclosed in JP 2011-109903 A, power can be transferred stably against lateral misalignments. However, this technique does not resolve variations in power transfer efficiency resulting from differences in distance between the ground (power transmission coil) and power receiving coils, which come from differences in size, shape, etc. among vehicles (e.g., a sport car and a large truck). That is to say, when a sports car and a large truck, i.e., a vehicle whose power receiving coil is distant from the power transmission coil, pass through the same power transmission area, the power transfer efficiency could be lower in the case of latter than former.

Further, if the power receiving coil is smaller than the power transmission coil, the power transfer efficiency, the possible power transfer distance and the like can decline, regardless of differences among vehicles. Furthermore, variations in coupling coefficient caused by changes in conditions such as the distance between the power transmission coil and the power receiving coil cause a decline in the power transfer efficiency. In order to solve these problems, it is necessary to provide an adjusting circuit in the power receiver to match the resonance frequencies.

### SUMMARY OF THE INVENTION

In order to solve the foregoing problems of the conventional art, it is an object of the present invention to provide a wireless power transfer system and a wireless power transfer method capable of performing power transfer with stable efficiency, while involving a displacement or a rotation of a power receiver.

It is also an object of the present invention to provide a wireless power transfer system and a wireless power transfer method capable of performing power transfer with stable efficiency without providing an adjusting circuit in a power receiver, while involving a displacement or a rotation of the power receiver.

The wireless power transfer system of the present invention is a system having a power transmitter including a power transmission resonator composed of a power transmission coil and a resonant capacitance; and a power receiver including a power receiving resonator composed of a power receiving coil and a resonant capacitance, thereby transferring power from the power transmitter to the power receiver through an interaction between the power transmission coil and the power receiving coil. The wireless power transfer system further includes a power transmission auxiliary device having an auxiliary resonator composed of an auxiliary coil and a resonant capacitance, the power transmission auxiliary device and the power transmission device are arranged so as to oppose each other, forming a power receiving space for placing the power receiving coil between the power transmission coil and the auxiliary coil, and power transfer is performed in the power receiving space while involving a movement of the power receiving coil including at least one of a displacement and a rotation.

The term “power receiving space” as used herein refers to an area (three dimensional space) through which a coil plane of the power transmission coil and that of the auxiliary coil overlap one another when the power transmission coil and the auxiliary coil are arranged to oppose each other. The term “coil plane” is defined as an area that is included in a plane perpendicular to the axis of the coil and including the center of the geometry of the coil, and is a projection of the perimeter of the coil perpendicular to the plane.

The wireless power transmission method of the present invention is a method that uses a power transmitter including a power transmission resonator composed of a power transmission coil and a resonant capacitance; and a power receiver including a power receiving resonator composed of a power receiving coil and a resonant capacitance, thereby transferring power from the power transmitter to the power receiver through an interaction between the power transmission coil and the power receiving coil. The method further uses a power transmission auxiliary device including an auxiliary resonator composed of an auxiliary coil and a resonant capacitance, a power receiving space for placing the power receiving coil is formed between the power transmission coil and the auxiliary coil by arranging the power transmission auxiliary device and the power transmission device to oppose each other, and power transfer is performed in the power receiving space while involving a movement of the power receiving coil including at least one of a displacement and a rotation.

According to the present invention, by placing the power receiving coil in the power receiving space between the power transmission coil and the auxiliary coil, while allowing the power receiving coil to displace or rotate, it is possible to increase the possible power transfer area between the power transmission coil and the power receiving coil in comparison with the case of arranging the power transmission coil alone. Therefore, power transfer can be performed with stable efficiency by suppressing variations in transfer efficiency resulting from movements of the power receiving coil.

Moreover, since the control for achieving high power transfer efficiency is simple, the cost of the wireless power transfer system can be reduced.

Further, even when the power receiving coil is smaller than the power transmission coil in size, declines in the power transfer efficiency, the possible power transfer distance, and the like can be reduced, so that power can be transferred with stable efficiency without providing the power receiver with a device for adjusting resonance frequencies. Consequently, the cost of the power receiver can be reduced.

### BRIEF DESCRIPTION OF THE DRAWINGS

FIG. 1 is a schematic cross-sectional view showing the configuration of a wireless power transfer system according to Embodiment 1.

FIG. 2A is a schematic cross-sectional view showing an arrangement of each element of a power transmission-side resonant system of the wireless power transfer system for VNA measurement.

FIG. 2B is a graph showing responses of the power transmission-side resonant system to a resonant frequency f3 of an auxiliary resonator, the responses being obtained as a result of the VNA measurement in the arrangement of FIG. 2A.

FIG. 2C (a) to 2C (c) show output waveform diagrams of the responses of the power transmission-side resonant system, the responses being obtained as a result of the VNA measurement in the arrangement of FIG. 2A. FIG. 2C (a) is a response to the resonant frequency f3=9 MHz of the auxiliary resonator, FIG. 2C (b) is a response, where f3=12.1 MHz, and FIG. 2C (c) is a response, where f3=16 MHz.

FIG. 3A is a schematic cross-sectional view showing an arrangement of each element of the wireless power transfer system according to Embodiment 1 for VNA measurement.

FIG. 3B is a graph showing the dependence of power transfer efficiency of the wireless power transfer system on the resonant frequency f3, the dependence being obtained as a result of the VNA measurement in the arrangement of FIG. 3A.

FIG. 4 is a diagram showing the relationship of resonance frequencies ftL and ftH of the power transmission-side resonant system with respect to a setting example of the relationship between respective resonance frequencies f1, f2, and f3 of the power transmission resonator, the power receiving resonator, and the auxiliary resonator of the wireless power transfer system.

FIGS. 5A and 5B are schematic cross-sectional views each showing an arrangement of each element of the wireless power transmission system for VNA measurement with and without the auxiliary coil.

FIG. 5C is a graph showing the dependence of power transfer efficiency on the center-to-center distance between the power transmission coil and the power receiving coil, the dependence being obtained as a result of the VNA measurement in the arrangements shown in FIGS. 5A and 5B.

FIG. 6A is a schematic cross-sectional view showing an arrangement of each element of the wireless power transfer system for power transfer.

FIG. 6B is a graph showing the relationship between the output power of the rectifier circuit and the center-to-center distance between the power transmission coil and the power receiving coil in the arrangement of the wireless power transfer system shown in FIG. 6A.

FIG. 7A is a schematic cross-sectional view showing an arrangement of each element of the wireless power transfer system for power transfer.

FIG. 7B is a graph showing the relationship between the output power of the rectifier circuit and the radial distance from the center of the power transmission coil in the arrangement of the wireless power transfer system shown in FIG. 7A.

FIGS. 8A to 8C are schematic cross-sectional views for explaining the basic configuration and operation of a wireless power transfer system according to Embodiment 2.

FIGS. 9A to 9C are schematic cross-sectional views showing first to third specific application examples of the wireless power transfer system according to Embodiment 2.

FIGS. 10A to 10C are schematic diagrams showing examples of the front shape of the wireless power transfer system of FIG. 9A seen from the power transmission coil 20 side.

FIGS. 11A to 11C are schematic cross-sectional views for explaining the basic configuration and operation of a wireless power transfer system according to Embodiment 3.

FIGS. 12A to 12C are schematic cross-sectional views showing first to third specific application examples of the wireless power transfer system according to Embodiment 3.

FIG. 13 is a schematic plan view showing the shape of the wireless power transfer system of FIG. 12C from the power transmission coil side.

FIGS. 14A to 14C are plan cross-sectional views respectively showing the configurations shown in FIG. 12A to 12C from the entrance side of the charging tunnel 36.

FIGS. 15A to 15C are schematic cross-sectional views showing modified examples of the basic configuration of the wireless power transfer system according to Embodiment 3, where the power transmission coils and the auxiliary coils are arranged to oppose each other in a horizontal direction.

FIG. 16A to 16C are schematic cross-sectional views respectively showing first to third application examples of the configuration of a wireless power transfer system according to Embodiment 4.

FIG. 17 is a schematic side view of the wireless power transfer system shown in FIG. 16B.

FIG. 18 is a schematic cross-sectional view showing the configuration of a wireless power transfer system according to Embodiment 5.

FIG. 19 is a schematic cross-sectional view showing the configuration of a wireless power transfer system according to Embodiment 6.

FIG. 20 is a cross-sectional view showing an exemplary conventional wireless power transfer system.

### DETAILED DESCRIPTION OF THE INVENTION

Based on the configuration as described above, the present invention may be modified as follows.

That is, power may be transferred from the power transmitter to the power receiver through magnetic field resonance between the power transmission coil and the power receiving coil.

Further, when the power receiving coil is placed in the power receiving space, it is preferable that axes of the power transmission coil, the auxiliary coil, and the power receiving coil are parallel to each other. Furthermore, it is preferable that the power receiving coil is axially parallel to the power transmission coil from the viewpoint of efficiency.

Further, the power receiving coil may travel in one direction inside the power receiving space. Alternatively, power transfer may be performed while involving a rotation and travel of the power receiving coil. Moreover, when the power receiving coil travels only in one direction, the power transmission coil or the auxiliary coil may rotate in tandem with the power receiving coil.

Further, the power receiving coil may be placed alone in the power receiving space. In this case, only one pair of the power transmission coil and the auxiliary coil may be used to transfer power to the power receiving coil. This can simplify the control system (including circuitry).

In this case, it is preferable that the resonant frequency f3 of the auxiliary resonator set such that the resonant frequency ft of the power transmission-side resonant system composed of the power transmission resonator and the auxiliary resonator coincides with the resonance frequency f2 of the power receiving resonator. Further, the resonant frequency f1 of the power transmission resonator, the resonant frequency f2 of the power receiving resonator, and the resonant frequency f3 of the auxiliary resonator may be set to satisfy the relationship f1=f2<f3 or f3<f1=f2. Further, the resonant frequency f1 of the power transmission resonator, the resonant frequency f2 of the power receiving resonator, and the resonant frequency f3 of the auxiliary resonator may be set to satisfy the relationship f2<f1=f3 or f1=f3<f2.

Here, the resonance frequency f3 of the auxiliary resonator may be set by providing the power transmission auxiliary with an adjusting variable capacitor as the resonant capacitor, and adjusting the adjusting variable capacitor. A plurality of power receiving coils may be placed in one power receiving space or a plurality of power transmission coils and auxiliary coils may be used to transfer power to one power receiving coil.

Further, it is preferable that the diameter d1 of the power transmission coil, the diameter d2 of the power receiving coil, and the diameter d3 of the auxiliary coil satisfy the relationship d1>d2 and d2<d3. If this relationship is maintained, effects such as an increase in possible power transfer distance can be achieved. It is particularly preferable that d1, d2 and d3 satisfy the relationship d1=d3 and d1>d2. This is highly effective in improving transfer efficiency characteristics (such as an increase in power receivable range). Similar effects can still be achieved by arranging not circular coils but, for example, rectangular coils.

Further, at least one of the power transmission coil and the auxiliary coil may be an air-core coil, and a through hole large enough to allow the power receiver to pass therethrough may be formed in the air-core coil at a core part. Furthermore, the power receiving coil may travel through at least one of the power transmission coil and the auxiliary coil.

Further, it is preferable that power transfer is performed in a state where the power receiver except the power receiving coil is entirely surrounded by a magnetic shielding material. This is because it is preferable, from the viewpoint of protection of human body, to perform power transfer in a state where the power receiver except the power receiving coil is entirely surrounded by a magnetic shielding material when a person is in the power receiver.

The wireless power transfer system can produce similar effects even if a plurality of the power receiving spaces are formed.

For example, the power receiving spaces may be arranged in one direction. That is, the power receiving spaces are arranged in one direction in sequence in the axial direction of the power transmission coils or in the direction perpendicular to the axial direction of the power transmission coils. The power receiving spaces may be arranged in one direction in a gentle curve. Here, it is preferable that in the power receiving space adjacent to the power receiving space in which the power receiving coil is located, another power receiving coil is not placed at the same time.

Moreover, the position of the power receiving coil may be monitored to supply power only to the power receiving space in which the power receiving coil is located. In this case, at least one of the power transmission coil and the auxiliary coil forming the power receiving space in which the power receiving coil is not located may be electrically opened. Further, the resonant capacitance used in the auxiliary resonator of the power receiving space in which the power receiving coil is placed may be varied from that of the auxiliary resonator of the power receiving space in which the power receiving coil is not placed. Such a configuration allows optimum power transfer. Alternatively, the resonant frequency of the auxiliary resonator of the power receiving space in which the power receiving coil is placed may be varied from that of the auxiliary resonator of the power receiving space in which the power receiving coil is not placed.

Further, the power transmission coils and the auxiliary coils may be arranged such that their central axes are concentric. In this case, the power transmission coils and the auxiliary coils may be arranged in alternate order in the arrangement direction of the power receiving spaces. In this case, it is preferable that the power transmission coils and the auxiliary coils are spaced evenly (the power receiving spaces are equal in width). It is particularly preferable that the central axes of the power transmission coils, the auxiliary coils and the power receiving coil are concentric.

Further, in each of the power receiving spaces, the power transmitting coil and the auxiliary coil forming a pair may be arranged to oppose each other in the direction perpendicular to the arrangement direction of the power receiving spaces.

Once an adjustment is made in the wireless power transfer system of the present invention as described above, almost no adjustment will be needed thereafter. Also, since the wireless power transfer system uses the power transmission auxiliary device that requires no circuitry for the power system or the control system, the cost of the wireless power transfer system as a whole can be reduced in comparison to the conventional technique in which power transmitters are arranged in sequence.

Hereinafter, embodiments of the present invention will be described with reference to the drawings. It should be noted that the following embodiments are examples for embodying the present invention and the principles of the present invention are not limited to the embodiments.

### Embodiment 1

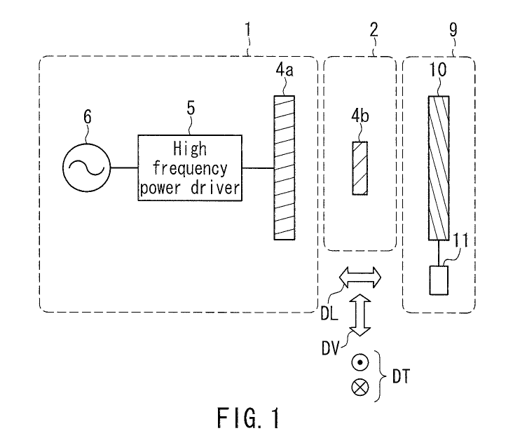

FIG. 1 is a schematic cross-sectional view showing the configuration of a wireless power transfer system of a magnetic field resonance type according to Embodiment 1. The present embodiment illustrates the basic concept of the wireless power transfer system of the present invention. Note that the same elements as those of the conventional wireless power transfer system shown in FIG. 20 are denoted by the same reference numerals, and the description thereof will not be repeated.

This wireless power transfer system includes a power transmission auxiliary device 9 in addition to the power transmitter 1 and the power receiver 2 of conventional technology, and is configured to perform wireless power transfer in a state in which the power receiver 2 is placed in a space between the power transmitter 1 and the power transmission auxiliary device 9. The power transmitter 1 converts power of an AC power supply (AC 100 V) into transferable high frequency power, and transfer the power, and the power receiver 2 receives the power. The power transmission auxiliary device 9 has the function of setting the resonant frequency of the resonant system relevant to the power transmitter 1 during power transfer to have an appropriate relationship with the resonant frequency of the resonant system of the power receiver 2.

The power transmitter 1 at least includes a high frequency power driver 5 that converts the power of the AC power supply (AC 100 V) 6 into transferable high frequency power and a power transmission coil 4a. The power transmitter 1 may be provided with a power transmission loop coil as needed. Although not being shown, a resonant capacitance is connected to the power transmission coil 4a, and they form a power transmission resonator. As the resonant capacitance, a variable capacitor or a fixed capacitor as a circuit element may be connected or a stray capacitance may be used. Note that in the following description, the resonant frequency f1 of the power transmission resonator alone may be referred to as “the resonant frequency f1 of the power transmitter 1” in order to facilitate understanding of the relationship with the illustration in the drawings.

The power transmission auxiliary device 9 includes an auxiliary coil 10 and an adjusting capacitor 11 serving as the resonant capacitance, and these elements form an auxiliary resonator. Note that in the following description, the resonant frequency f3 of the auxiliary resonator alone may be referred to as “the resonant frequency f3 of the power transmission auxiliary device 9” in order to facilitate understanding of the relationship with the illustration in the drawings. As the adjusting capacitor 11, a fixed capacitor having a capacitance value appropriately set as below may be used, or a variable capacitor may be used so that the capacitance value can be readjusted.

Although not being shown, the wireless power transfer system may include, as needed, means for monitoring, for example, the reflected power, the resonant frequency, the flowing current, or the voltage of the power transmission coil 4a, and a circuit or the like for allowing the power transmitter 1, the power receiver 2, and the power transmission auxiliary device 9 to exchange information with each other. In the case of adopting such a configuration, it is possible to use a variable capacitor as the adjusting capacitor 11 to control the capacitance value automatically.

The power receiver 2 is provided with at least a combination of the power receiving coil 4b and a loop coil (not shown). As shown in FIG. 20, the power obtained through the loop coil is stored in the rechargeable battery at least via a rectifier circuit. The power obtained through the loop coil may be transferred directly to a load, such as a motor, as needed. A resonant capacitance (not shown) is connected to the power receiving coil 4b, and they form a power receiving resonator. As the resonant capacitance, a variable capacitor or a fixed capacitor as a circuit element may be connected, or a stray capacitance may be used. Note that in the following description, the resonant frequency f2 of the power receiving resonator alone may be referred to as “the resonant frequency f2 of the power receiver 2” in order to facilitate understanding of the relationship with the illustration in the drawings.

As shown in FIG. 1, a power receiving space is formed between the power transmission coil 4a and the auxiliary coil 10 by arranging the power transmission auxiliary device 9 and the power transmitter 1 to oppose each other, and the power receiver 2 including the power receiving coil is placed in the power receiving space. The present embodiment is characterized in that power transfer is performed in a state where the power receiver 2 is moving (at least one of displacement and rotation) inside the power receiving space. That is, the wireless power transmission system is configured to perform power transfer to the power receiver 2 involving movements of the power receiver 2 such as displacements in the lateral direction as indicated by the arrow DL, displacements in the vertical direction as indicated by the arrow DV, displacements in the plane direction parallel to the power transmission auxiliary device 9 and the power transmitter 1 as indicated by the signs DT or rotations (not shown). These movements are used alone or in combination of two or more.

Such a characteristic of the wireless power transfer system according to the present embodiment is based upon the use of the power transmission auxiliary device 9. Therefore, hereinafter, the functions of the power transmission auxiliary device 9 will be explained in more detail. According to the above-described configuration, coupling between the power transmission coil 4a and the auxiliary coil 10 forms a resonant system composed of a power transmission resonator including the power transmission coil 4a and an auxiliary resonator including the auxiliary coil 10. In the following description, this resonant system is referred to as the “power transmission-side resonant system”. Further, the resonant frequency of the power transmission-side resonant system is referred to as “ft”.

According to the configuration of the wireless power transfer system shown in FIG. 1, effects such as an increase in the possible power transfer distance can be achieved as will be described later, in comparison to a configuration without the power transmission auxiliary device 9. The reason for this seems to be that the reaching distance of the magnetic flux from the power transmission coil 4a is increased by arranging the auxiliary coil 10 to oppose the power transmission coil 4a.

On the other hand, in the configuration as shown in FIG. 1, the resonant frequency of the power transmitter 1 is different from the initially set resonant frequency f1 of the power transmission resonator alone, under a magnetic influence of the auxiliary coil 10. However, it is possible to coincide the resonant frequency ft of the power transmission-side resonant system with the resonant frequency f2 of the power receiver 2 by appropriately setting the resonant frequency f3 of the power transmission auxiliary device 9 by adjusting the capacitance value C of the adjusting capacitor 11 that is connected to the auxiliary coil 10. As a result, the efficiency of transferring power from the power transmission coil 4a is maintained at a practically sufficient level, thus achieving effects such as an increase in the possible power transfer distance.

Although it is desirable that the capacitance value C of the adjusting capacitor 11 is set such that the resonant frequency ft coincides with the resonant frequency f2, an appropriate effect can be achieved even if the two frequencies do not coincide completely with each other. That is, the resonant frequency f3 of the power transmission auxiliary device 9 may be set such that the peak of the resonant frequency ft of the power transmission-side resonant system is brought closer to the resonant frequency f2 of the power receiver 2 than the resonant frequency f1 of the power transmitter 1. To obtain sufficiently the effects achieved by such adjustment, it is desirable that the shape of the auxiliary coil 10 of the power transmission auxiliary device 9 is substantially the same as that of the power transmission coil 4a, and that the central axes of the two coils are arranged substantially coaxially.

Further, effects such as an increase in the possible power transfer distance can be achieved appropriately if the relationship d1>d2, and d2<d3 is satisfied, where d1 is the diameter of the power transmission coil 4a, d2 is the diameter of the power receiving coil 4b, and d3 is the diameter of the auxiliary coil 10. The reason for this is that if the diameter d1 of the power transmission coil 4a is larger than the diameter d2 of the power receiving coil 4b, the magnetic flux between the power receiving coil 4b and the auxiliary coil 10 can be utilized, and if the diameter d3 of the auxiliary coil 10 is larger than the diameter d2 of the power receiving coil 4b, the magnetic flux between the power receiving coil 4b and the power transmission coil 4a can be utilized.

Here, in order to examine the influence of the auxiliary coil 10, a VNA (vector network analyzer) measurement was performed using micro power, and the results of the measurement will be described below. The resonant frequency f1 of the power transmitter 1 and the resonant frequency f2 of the power receiver 2 were set by the capacitance values of respective fixed capacitors provided as the resonant capacitances. Specifically, they were set such that f1=f2=12.1 MHz.

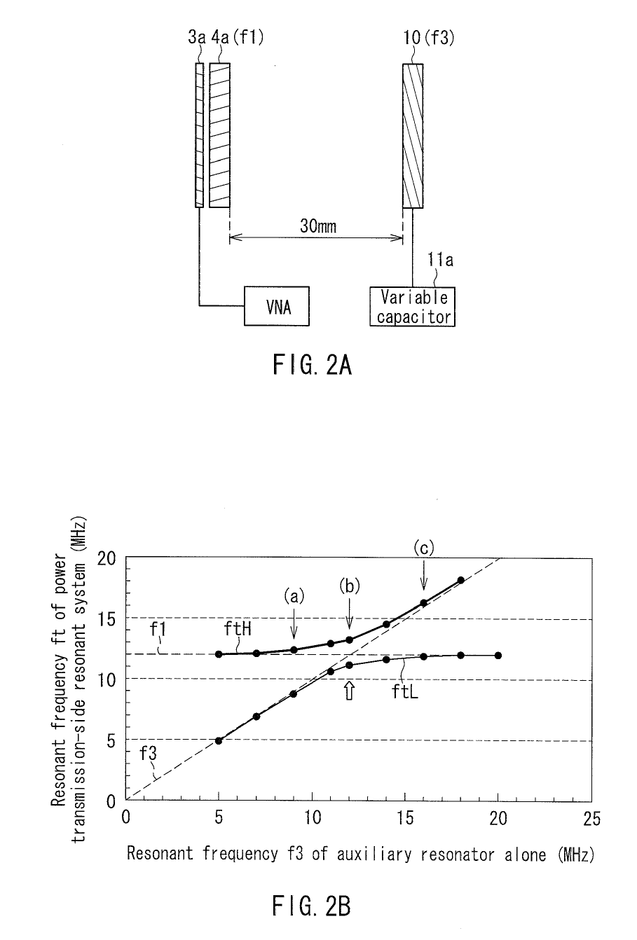

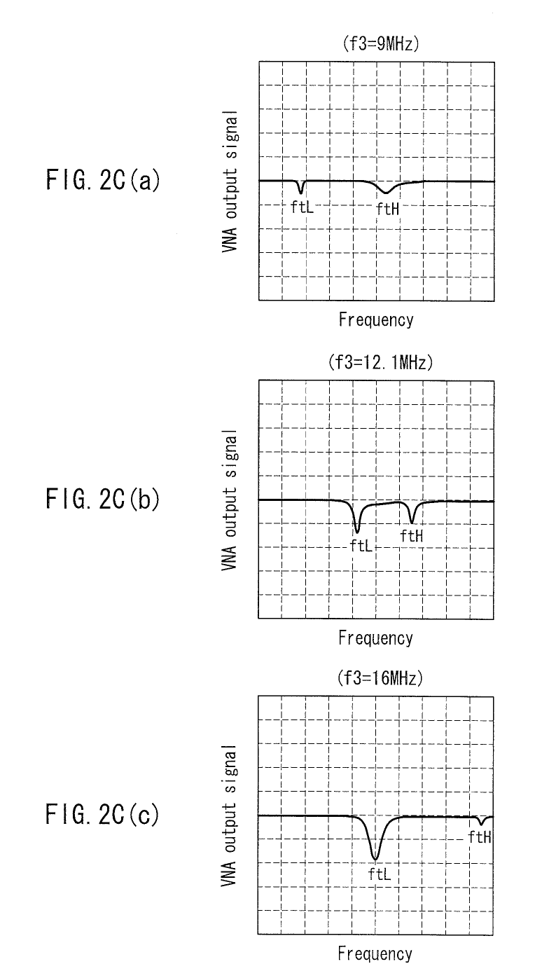

First, a description will be given of results of examining the change in the resonant frequency of the power transmission-side resonant system when the resonant frequency f3 of the power transmission auxiliary device 9 was changed. FIG. 2A shows an exemplary arrangement of each coil used in the test. More specifically, the power transmission coil 4a and the auxiliary coil 10 were arranged to oppose each other to form a power receiving space having a length of 30 mm, and a VNA was connected to the loop coil 3a. An adjusting variable capacitor 11a serving as the adjusting capacitor was connected to the auxiliary coil 10, and the resonant frequency f3 was set to be variable.

FIG. 2B shows the results of the VNA measurement in this arrangement. In FIG. 2B, the horizontal axis represents the value of the resonant frequency f3 of the auxiliary resonator alone, and the vertical axis represents the value of resonant frequency ft of the power transmission-side resonant system obtained in the VNA measurement. Further, FIG. 2C (a) shows an output waveform diagram where the resonant frequency f3 was set to 9 MHz, FIG. 2C (b) shows an output waveform diagram where the resonant frequency f3 was set to 12.1 MHz, and FIG. 2C (c) shows an output waveform diagram where the resonant frequency f3 was set to 16 MHz in the VNA measurement.

For example, when f3 was adjusted to the same resonant frequency as f1 (12.1 MHz), two resonant frequencies centered about 12.1 MHz appeared (close coupling: bimodal characteristics) as shown in the waveform diagram of FIG. 2C (b). The lower resonant frequency on the left is referred to as “ftL”, and the higher resonant frequency on the right is referred to as “ftH”. In FIG. 2B, a characteristic line corresponding to the lower resonant frequency ftL and a characteristic line corresponding to the higher resonant frequency ftH are plotted. The present invention is highly effective under the conditions where bimodal characteristics are obtained.

As the resonant frequency f3 of the auxiliary resonator alone is changed to 20 MHz from the state in FIG. 2C (b), the lower resonant frequency ftL gradually shifts to the higher frequency side as shown in FIG. 2B, and eventually is brought close to 12.1 MHz, which is equal to f1 and f2, and the signal amplitude increases as shown in FIG. 2C (c). Although the higher resonant frequency ftH also shifts to the higher frequency side, the signal amplitude decreases and approaches zero (FIG. 2C (c)).

On the other hand, as the resonant frequency f3 is changed toward the lower frequency side to 5 MHz from the state in FIG. 2C (b), the higher resonant frequency ftH gradually shifts to the lower frequency side as shown in FIG. 2B, and eventually is brought close to 12.1 MHz, which is equal to f1. However, as shown in FIG. 2C (a), the signal amplitude does not significantly increase, as compared with the lower resonant frequency ftL. The lower resonant frequency ftL also gradually shifts to the lower frequency side, and the signal amplitude decreases and approaches zero.

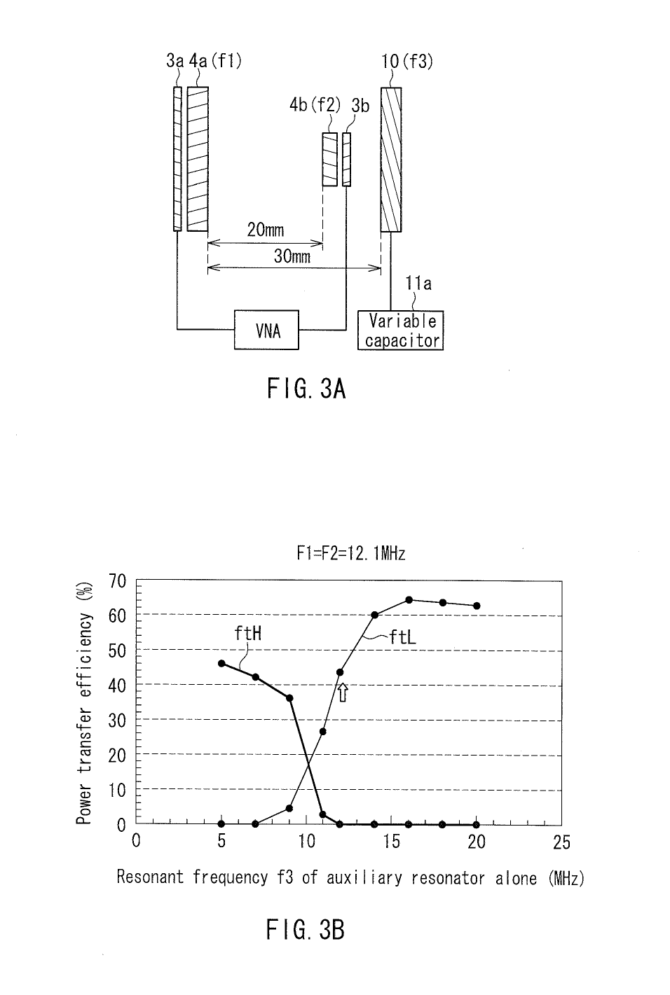

Next, a description will be given of results of examining the change in the power transfer efficiency when the coils were arranged as shown in FIG. 3A and the resonant frequency f3 of the power transmission auxiliary device 9 was changed. The arrangement in FIG. 3A is configured by placing the power receiving coil 4b and the loop coil 3b in the power receiving space between the power transmission coil 4a and the auxiliary coil 10 in the arrangement of FIG. 2A. The VNA was connected to the loop coils 3a and 3b. Note that the power transfer efficiency as used herein refers to a value of power transfer efficiency between the power transmission coil 4a and the power receiving coil 4b, and does not include the efficiency of the circuit and the like.

FIG. 3B shows results of the VNA measurement in this arrangement. In FIG. 3B as well, a characteristic line corresponding to the lower resonant frequency ftL and a characteristic line corresponding to the higher resonant frequency ftH are plotted. As can be seen from FIG. 3B, for example, when f3=f1=f2=12.1 MHz (indicated by the arrow), the power transfer efficiency is as small as about 44%. As f3 is increased further, the power transfer efficiency corresponding to the lower resonant frequency ftL increases. When f3=16 MHz, a power transfer efficiency of about 64% can be obtained.

As described above, increasing the resonant frequency f3 of the power transmission auxiliary device 9 to be larger than f1 and f2 causes the resonant frequency ft for power transfer to be brought closer to the resonant frequency f2, thereby increasing the power transfer efficiency at that time.

On the other hand, as the resonant frequency f3 is changed to the low frequency side, the power transfer efficiency corresponding to the higher resonant frequency ftH increases. When f3=5 MHz, a power transfer efficiency of about 46% can be obtained. However, the value in the maximum region of the power transfer efficiency corresponding to the higher resonant frequency ftH is smaller than the value in the maximum region of the power transfer efficiency corresponding to the lower resonant frequency ftL.

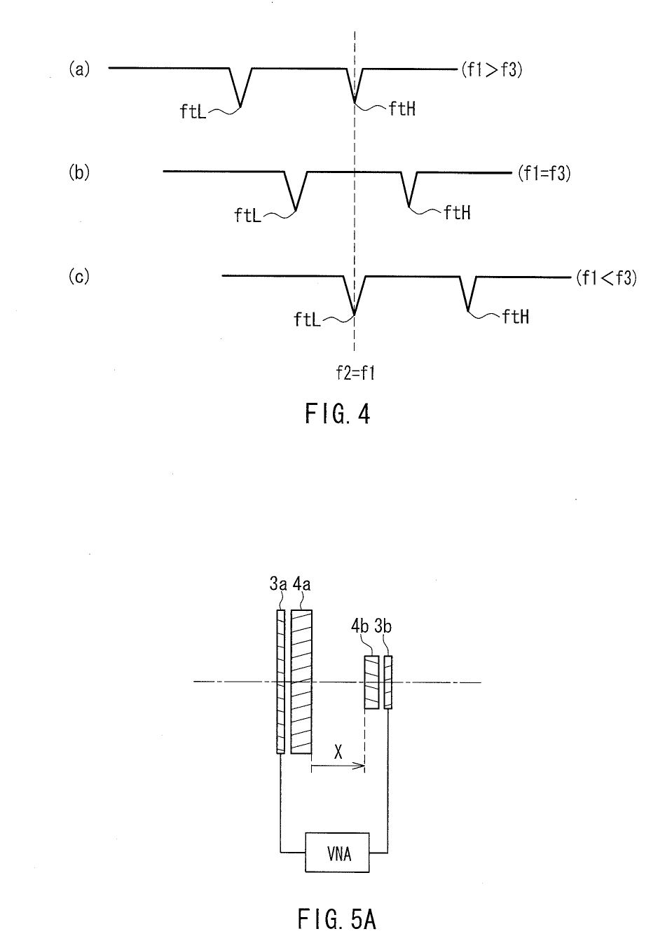

FIG. 4 shows the relationship of the resonant frequency ft of the power transmission-side resonant system with setting examples of the relationship between the resonance frequencies f1, f2, and f3. In the example shown in FIG. 4, the relationship is set to f1=f2. In this case, ftH can be coincided with f2, and ftH can be brought sufficiently close to f2 by appropriately setting f3 within the range of f1>f3 as shown in (a). Bringing ftH sufficiently close to f2 means that the resonant frequency ft is brought into a state in which ft is close to f2 to the extent that an obtained power transfer efficiency is practically equal to that obtained when the resonant frequency ft coincides with the resonant frequency f2 as shown in FIG. 3B. In the following description, the meaning of the resonant frequency ft being coincided with the resonant frequency f2 includes a resonant frequency ft that is sufficiently close to the resonant frequency f2.

FIG. 4 (b) shows a case where ft does not coincide with f2 since the relationship is set such that f1=f2=f3 as described above. By appropriately setting f3 within the range of f1<f3 as shown in (c), ftL can be coincided with f2.

As described above, if the resonant frequency 13 of the power transmission auxiliary device 9 is different from the resonant frequency f2 of the power receiver 2 (f3≠f2), it is possible to achieve an appropriate effect of making the resonant frequency ft of the power transmission-side resonant system to coincide with the resonant frequency f2. Note, however, that it is preferable that the relationship f3>f2 is satisfied.

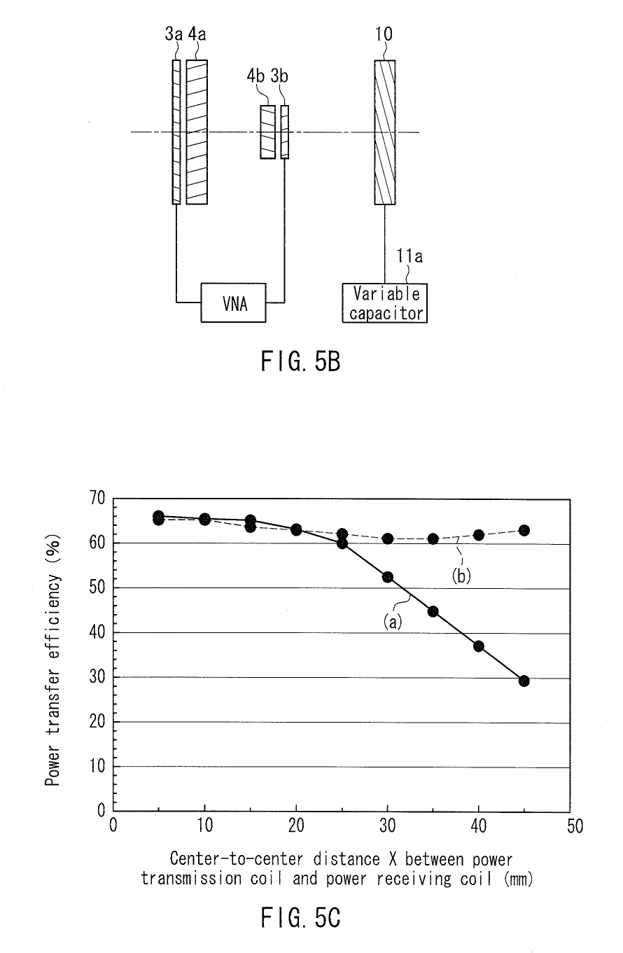

Next, the results of examining whether the presence or absence of an auxiliary coil causes changes in the power transfer efficiency will be described. VNA measurement was performed in the arrangement without an auxiliary coil as shown in FIG. 5A and in the arrangement with the auxiliary coil 10 as shown in FIG. 5B. In the VNA measurement in the arrangement of FIG. 5A, the power transfer efficiency between the coils was examined by varying the distance X between the power transmission coil 4a and the power receiving coil 4b. In the VNA measurement in the arrangement of FIG. 5B, the power transfer efficiency between the coils was examined by fixing the center-to-center distance between the power transmission coil 4a and the opposing auxiliary coil 10 to 50 mm, placing the power receiver 2 between the two coils, and varying the distance X between the power transmission coil 4a and the power receiving coil 4b. The power transmission coil 4a and the auxiliary coil 10 had a diameter of about 70 mm, and the power receiving coil 4b had a diameter of about 20 mm. The adjusting variable capacitor 11a attached to the auxiliary coil 10 was adjusted such that the resonance frequency ftL of the power transmission-side resonant system and the power receiving-side resonance frequency f2 were each 12.1 MHz during power transfer.

FIG. 5C shows the dependence of the power transfer efficiency on the center distance X between the power transmission coil 4a and the power receiving coil 4b. In the case of the conventional arrangement without the auxiliary coil 10 (FIG. 5A), the power transfer efficiency declined as the position of the power receiving coil 4b moved away from the power transmission coil 4a, as indicated by the line (a). That is, the power transfer efficiency started to decline when the distance (X) between the resonant coils at the coil center was about 25 mm (X=25 mm), and the power transfer efficiency at X=45 mm was about 35% lower than that at X=5 mm. In contrast, in the case of the present embodiment where the auxiliary coil 10 was provided (FIG. 5B), the level of decline in the power transfer efficiency was 5 to 6% in a range up to X=45 mm, as indicated by the line (b). It seems that such results are obtained because the magnetic flux flows easily between the power transmission coil 4a and the auxiliary coil 10, thereby improving the characteristics such as the power transfer efficiency and the possible power transfer distance in comparison with the conventional configuration.

In this way, by placing the power transmission auxiliary device 9 posterior to the power receiver 2 and matching the resonant frequency f2 of the power receiving resonator with the resonant frequency ft of the power transmission-side resonant system during power transfer, the possible power transfer distance can be significantly increased in comparison with the conventional configuration without the power transmission auxiliary device 9.

Further, in a conventional wireless power transfer device of a magnetic field resonance type, if the resonance frequency of the power transmission resonator is set to, for example, 12.1 MHz, it is necessary to also set the resonance frequency of the power receiving resonator to 12.1 MHz. However, when the power receiver 2 is small, the shape of the power receiving coil 4b becomes also small (L being small), so that it may be difficult to match the resonance frequency of the power receiver 2 with that of the power transmitter during power transfer. In contrast, in the present embodiment, it is possible to match the resonance frequency of the power transmission-side resonant system with that of the power receiving-side resonant system by controlling the adjusting variable capacitor 11a of the power transmission auxiliary device 9, so that there is no need to provide the power receiver 2 with a device for matching the resonance frequency of the power receiving resonator with that of the power transmission resonator. Accordingly, the present embodiment is particularly effective when the power receiver 2 is small.

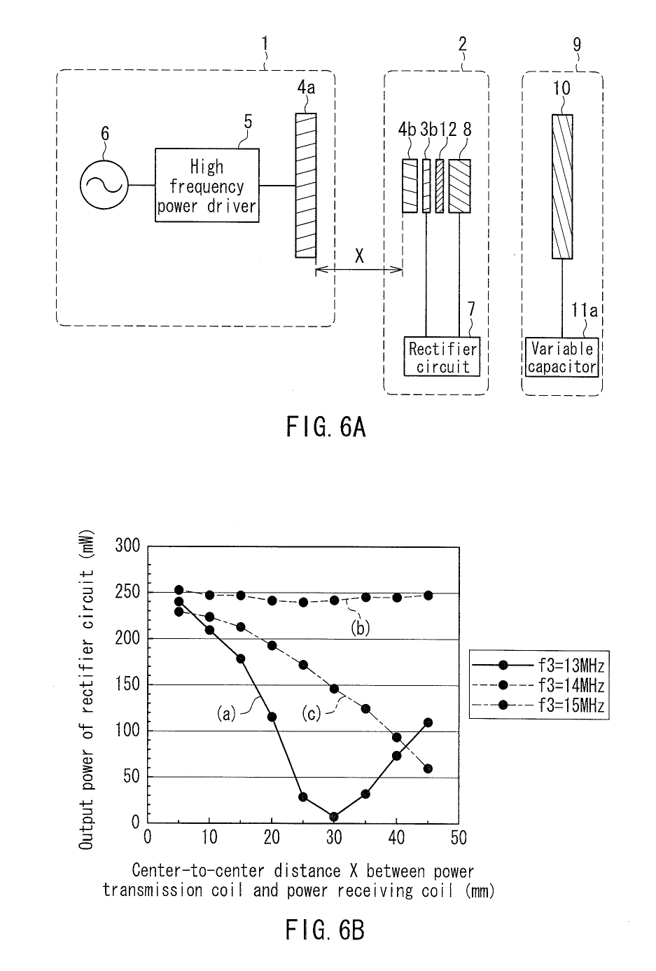

Next, with reference to FIGS. 6A and 6B, a description will be given of the results of examining the power transmission characteristics in the case of using the actual power receiver 2 including a rechargeable battery 8. FIG. 6A is a schematic cross-sectional view showing the arrangement of each element of the power transfer system. The power transmission coil unit shown in FIG. 6A is composed only of the power transmission coil 4a. A power transmission loop coil may be provided as needed. As the power receiving coil unit, the power receiving coil 4b and the loop coil 3b are arranged in combination. Power obtained through the loop coil 3b is stored in the rechargeable battery 8 via the rectifier circuit 7.

When using a small battery (such as a coin battery) as the rechargeable battery 8, it is preferable to reduce an installation area by stacking the loop coil 3b and the rechargeable battery 8 on top of each other (e.g., such as the coil on the battery). In this case, a magnetic flux leaks from the loop coil 3b into the rechargeable battery 8 and causes an eddy current, giving rise to a loss (eddy current loss). Therefore, it is desirable to place between the loop coil 3b and the rechargeable battery 8 a radio wave absorber 12 having high magnetic permeability at the resonant frequency during transfer. Further, the loop coil 3b and the rechargeable battery 8 may be brought into intimate contact with each other through the radio wave absorber 12 so as to reduce the total thickness.

In the present embodiment, the power transmission coil 4a has the same function as that of its counterpart shown in FIG. 20. However, a planar coil obtained by spirally winding a Cu coil (with coating) having a diameter of about 1 mm on the same plane is used in order to reduced a thickness. Furthermore, the loop coil 3b and the power receiving coil 4b of the power receiver 2 have the same function as that of their counterparts shown in FIG. 20 but they are formed of a thin-film coil obtained by forming, in a spiral form, a Cu foil having a thickness of about 70 μm on the same plane on a thin printed-circuit board having a thickness of 0.4 mm, in order to reduce a size. The shape of the power transmission coil 4a, the auxiliary coil 10 or the power receiving coil 4b may be changed depending on the power that needs to be transferred. When several kW of power is required as in an electric vehicle or the like, the power transmission coil 4a may have a diameter of 20 cm or more. The manner in which each coil is wound may be changed in accordance with the purpose. For example, the coils may be wound densely at the periphery (air-core coils) or loosely from the center to the periphery.

FIG. 6B is a graph showing the relationship between the output power of the rectifier circuit 7 and the distance between the power transmission coil 4a and the power receiving coil 4b at the coil center in the arrangement of FIG. 6A. Here, the intrinsic resonant frequency of each of the power transmission coil 4a and the power receiving coil 4b is 13.6 MHz. The center-to-center distance between the power transmission coil 4a and the auxiliary coil 10 is fixed to 50 mm, and the power receiving coil 4b is moved inside the power receiving space to vary the distance (X) between the power transmission coil and the power receiving coil at the coil center. The resonance frequency f3 of the power transmission auxiliary device 9 is set to 13 MHz, then to 14 MHz, and finally to 15 MHz by adjusting the adjusting variable capacitor 11a connected to the auxiliary coil 10, and the measurement is performed at each frequency.

In FIG. 6B, the line (a) indicates the relationship where f3 is set to 13 MHz, the line (b) indicates the relationship where f3 is set to 14 MHz, and the line (c) indicates the relationship where f3 is set to 15 MHz. From these results, the following is found. In the case of (a) where f3 is set to 13 MHz, the output power of the rectifier circuit 7 becomes the smallest when the power receiving coil 4b is at the position where X=about 30 mm. In the case of (c) where f3 is set to 15 MHz, the output power of the rectifier circuit 7 declines as the power transmission coil 4a moves away from the power receiving coil 4b. In contrast, in the case of (b) where f3 is set to 14 MHz, the value of the output power of the rectifier circuit 7 remains constant at a high level so long as the power receiving coil 4b is in the power receiving space. That is, power can be received stably even if the power coil 4b moves inside the power receiving space.

In actual power transfer, the resonant frequency f0 of the high frequency power driver 5 is important. That is, in the case of the setting shown in FIG. 6A, it is preferable that f0=f1=f2≠f3, and it is more preferable that f0=f1=f2<f3.

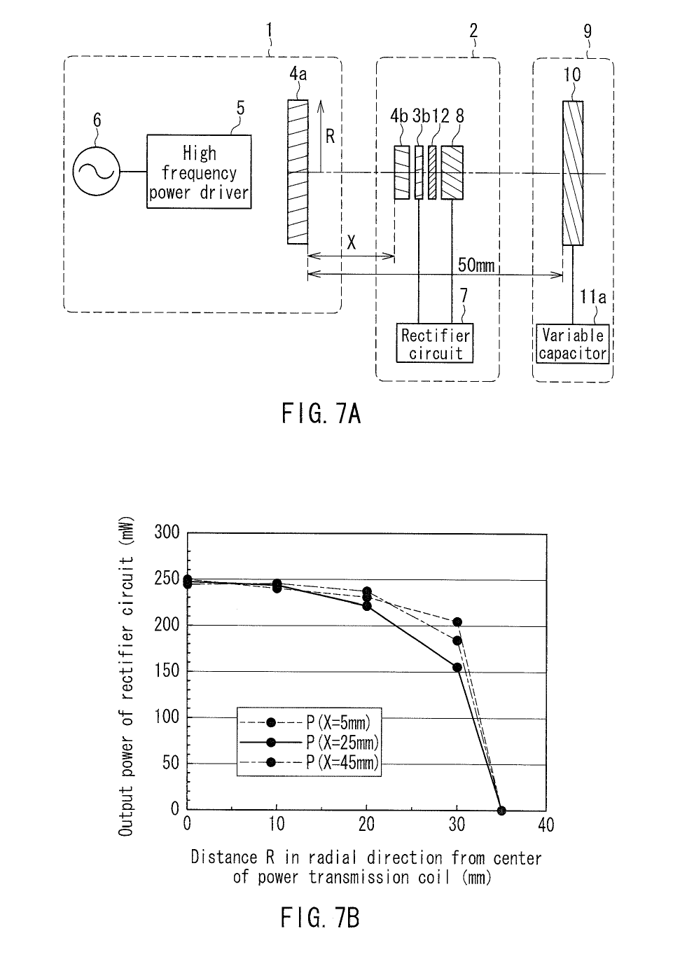

Next, with reference to FIGS. 7A and 7B, a description will be given of the results of examining the influence, on power received by the actual power receiver 2, of deviations in a radial direction between the central axes of the power transmission coil 4a and the power receiving coil 4b. The arrangement of each element shown in FIG. 7A used for the measurement is the same as the arrangement shown in FIG. 6A. The measurement was performed by varying the distance R between the power transmission coil 4a and the power receiving coil 4b in the radial direction as well as the distance (X) between the power transmission coil and the power receiving coil.

FIG. 7B shows variations in the dependence of received power on the radial direction distance R in response to the distance (X) between the power transmission coil and the power receiving coil. As can be seen from FIG. 7B, practically sufficient power can be received uniformly in the area of a cylindrical space defined by the distance X=45 mm or less and the radial direction distance R=15 mm or less (within the range of diameter of 30 mm) (the degree of variation is about 10%). That is, as long as the power receiving coil 4b is in the area of this cylindrical space, power can be transferred stably, for example, while moving the power receiving coil 4b.

In the present embodiment, the power obtained by the power receiver 2 is used to charge the rechargeable battery 8. Even when power is transferred directly to a load such as a motor, the present invention can also be applied in a like manner.

### Embodiment 2

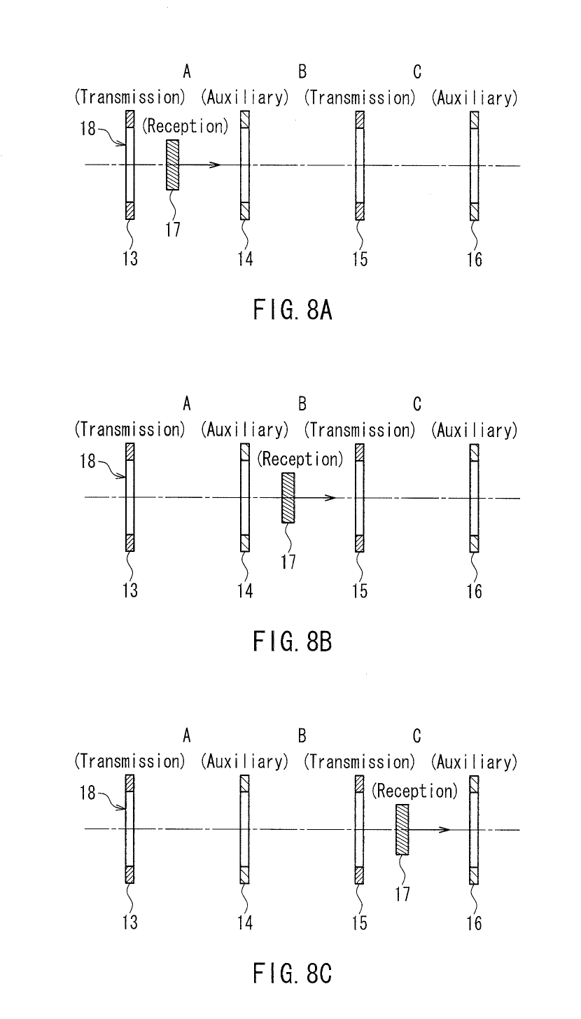

The basic configuration of a wireless power transfer system according to Embodiment 2 will be described with reference to FIGS. 8A to 8C. FIGS. 8A to 8C are schematic cross-sectional views showing the configuration and operation of the wireless power transfer system according to the present embodiment. That is, from FIG. 8A to FIG. 8C show an exemplary operation where a power receiver travels in one direction. In order to facilitate understanding of the illustrations in these drawings, a power transmission coil included in a power transmission device, an auxiliary coil included in a power transmission auxiliary device, and a power receiving coil included in a power receiver are shown schematically. The same goes for the embodiments described later.

In the configuration shown in FIGS. 8A to 8C, a power transmission coil 13, an auxiliary coil 14, a power transmission coil 15, and an auxiliary coil 16 are arranged in order along their axial direction. The power transmission coil 13 and the auxiliary coil 14 oppose each other and form a power receiving space A, the auxiliary coil 14 and the power transmission coil 15 oppose each other and form a power receiving space B, and the power transmission coil 15 and the auxiliary coil 16 oppose each other and form a power receiving space C. In this way, the power receiving spaces A, B and C are formed in sequence along the axial direction of the coils. The respective axes of the power transmission coils 13, 15 and the auxiliary coils 14, 16 are parallel to each other.

The power receiving coil 17 travels in the axial direction of the power transmission coils 13, 15 while maintaining its posture such that the axis is parallel to those of the power transmission coils 13, 15. By using air-core coils having no coil wire at the core part as the power transmission coils 13, 15 and the auxiliary coils 14, 16, the power receiving coil 17 can travel inside the coils through the inner space. It is essential that the outer diameter of the power receiving coil 17 is smaller than the inner diameter of through holes 18 forming the inner space in the power transmission coils 13, 15 and the auxiliary coils 14, 16. In reality, the power receiver including the power receiving coil 17 needs to be smaller than the inner diameter of the through holes 18.

Next, how the operation of each of the power transmission coils 13, 15 and the auxiliary coils 14, 16 is controlled when the power receiving coil 17 travels inside the power receiving spaces A, B, and C will be described. First, it is basic that the power transmission coils and the auxiliary coils forming all of the power receiving spaces in which the power receiving coil 17 is absent are turned off (e.g., electrically open).

When the power receiving coil 17 enters the power receiving space A as shown in FIG. 8A, the power transmission coil 13 and the auxiliary coil 14 are turned on (e.g., electrically conducting). As a result, a high frequency power driver of a power transmitter starts transferring power through the power transmission coil 13. In this case, since the resonance frequency f3 of the auxiliary resonator has been adjusted in advance in a state where the power receiving coil 17 is present, power can be transferred stably at any position within the power receiving space A.

When the power receiving coil 17 enters the power receiving space B as shown in FIG. 8B after passing through the power receiving space A, the power transmission coil 13 is turned off and the power transmission coil 15 is turned on at the same time. As a result, power transfer from the power transmission coil 15 to the power receiving coil 17 starts. Similarly, when the power receiving coil 17 enters the power receiving space C as shown in FIG. 8C, the auxiliary coil 14 is turned off and the auxiliary coil 16 is turned on at the same time. Consequently, power transfer from the power transmission coil 15 to the power receiving coil 17 continues. When the power receiving coil 17 passes through the auxiliary coil 16, the power transmission coil 15 and the auxiliary coil 16 are turned off, and power transfer to the power receiving coil 17 stops.

In this way, by placing only one power receiving coil 17 in one power receiving space and using one pair of the power transmission coil 13 or 15 and the auxiliary coil 14 or 16 to transfer power, the control system can be simplified. In this case, in each of the power receiving spaces A, B and C, the resonance frequency f3 of the auxiliary resonator is set such that the resonance frequency ft of the power transmission-side resonant system composed of the power transmission resonator and the auxiliary resonator coincides with the resonant frequency f2 of the power receiving resonator. Therefore, the resonant frequency f3 of the auxiliary resonator is set by providing the power transmission auxiliary device with an adjusting variable capacitor as a resonant capacitance, and adjusting the adjusting variable capacitor. Alternatively, the conditions under which the power receiving coil 17 is present in the power receiving space may be optimized by setting the resonant frequency f3 of the auxiliary resonator by means of a fixed capacitor.

Moreover, of the power receiving spaces A, B, and C, power is supplied only to the one in which the power receiving coil 17 is present by monitoring the position of the power receiving coil 17. Specifically, by providing each of the power transmission coils 13, 15 or each of the auxiliary coils 14, 16 with a position sensor (not shown), the passage of the power receiving coil 17 through a power transmission coil or auxiliary coil can be detected.

Further, it is desirable to prevent magnetic fields of a power receiving space in which the power receiving coil 17 is present from being affected by adjacent power transmission and auxiliary coils. For example, the power transmission coil or auxiliary coil of the power receiving space in which the power receiving coil 17 is not placed is electrically opened. Alternatively, the resonant capacity used in the auxiliary resonator is switched depending on the presence or absence of the power receiving coil. The system is configured in this way to allow optimum power transfer. When the resonant capacity is switched, the resonance frequency f3 of the auxiliary resonator of the power receiving space without the power receiving coil 17 is different from the resonance frequency f3 of the auxiliary resonator of the power receiving space with the power receiving space 17.

Further, when the power transmission coils 13, 15 and the auxiliary coils 14, 16 are arranged coaxially as in the present embodiment, it is preferable that the power transmission coils and the auxiliary coils are arranged in alternate order and the coil-to-coil spacings (the width of the power receiving spaces) are substantially identical with one another. This is because such an arrangement makes it easier to control the resonance frequency f3 of each auxiliary resonator. Further, it is particularly preferable that the central axes of the power transmission coils 13, 15, the central axes of the auxiliary coils 14,16 and the central axis of the power receiving coil 17 are coaxial because such an arrangement results in improved transfer efficiency.

One of the features of the present embodiment is that the power transmission coils and the auxiliary coils are air-core coils and they each have a through hole large enough to allow the power receiver to pass therethrough. Thus, the outer diameter of the power receiving coil is smaller than the inner diameter of the power transmission coils and the auxiliary coils. The power receiving coil can pass through the through holes in the power transmission coils and the auxiliary coils smoothly in sequence. Moreover, effects such as an increase in possible power transfer distance can be achieved if the relationship d1>d2, and d2<d3 is satisfied, where d1 is the diameter of each power transmission coil, d2 is the diameter of the power receiving coil, and d3 is the diameter of each auxiliary coil. It is particularly preferable that the relationship d1=d3 and d1>d2 is satisfied. This is highly effective in improving the transfer efficiency characteristics (e.g., an increase in power receivable range). Similar effects can still be achieved by arranging not circular coils but, for example, rectangular coils.

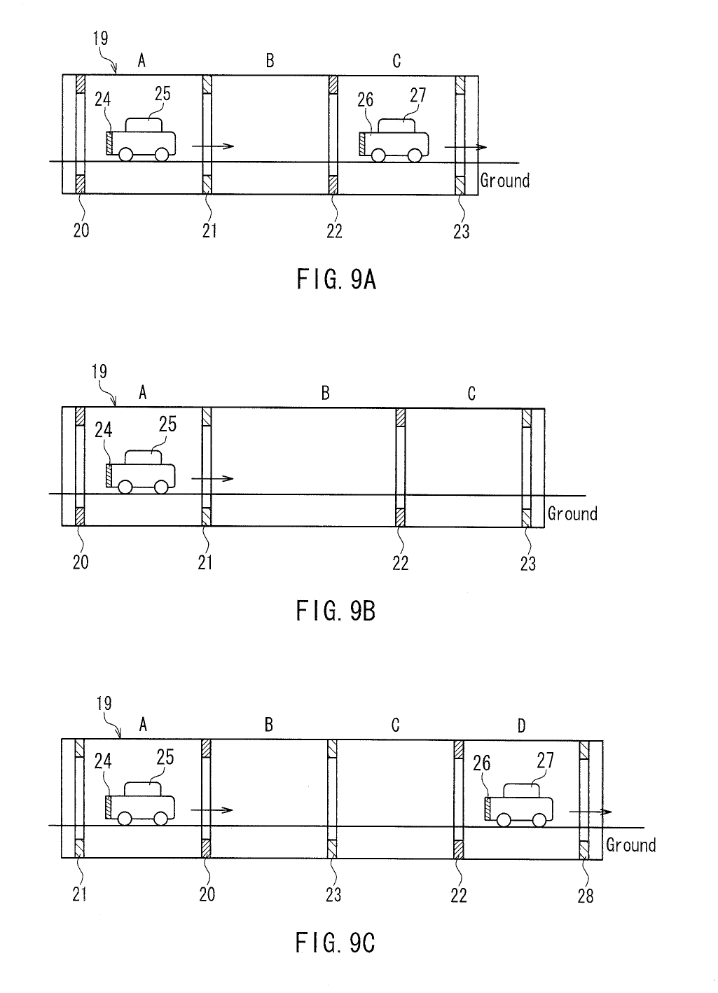

FIGS. 9A to 9C are schematic cross-sectional views showing first to third examples of applying the configuration of the present embodiment to a case where a vehicle equipped with a power receiving coil travels in one direction. Here, it is assumed that the vehicle is a toy racing car.

In the first application example shown in FIG. 9A, power transmission coils 20, 22 and auxiliary coils 21, 23 are arranged inside a charging tunnel 19 such that they are spaced substantially evenly to form power receiving spaces A, B and C. A vehicle 25 equipped with a power receiving coil 24 and a vehicle 27 equipped with a power receiving coil 26 travel through this charging tunnel 19. When the total number of the power transmission coils and the auxiliary coils is an even number as in this case, the number of the power transmission coils and that of the auxiliary coils are equal and arranged in alternate order. As a result, an odd number of power receiving spaces are formed.

The power receiving coils 24, 26 can be mounted on either the front-end or the rear-end of the vehicles 25, 27. To enhance the transfer efficiency, it is desirable that the power receiving coils 24, 26 are mounted such that axes thereof are parallel to those of the power transmission coils 20, 22 and the auxiliary coils 21, 23. Further, the first coil at the entrance of the charging tunnel 19 may be a power transmission coil or an auxiliary coil. The power transmission coils and the auxiliary coils are air-core coils, and the relationship in terms of size is as explained above in connection with the configuration of FIG. 8.

In order to reduce the influence of adjacent power receiving spaces, in, for example, the power receiving space adjacent to the power receiving space A where the power receiving coil 24 is located, the other power receiving coil 26 is preferably not located at the same time. However, the power receiving coils may be placed in adjacent power receiving spaces (e.g., the power receiving spaces B and C) at the same time as needed. In this case, it is necessary to carry out such control as switching the capacitors of both the auxiliary coils 21, 23 so that the auxiliary resonators have a predetermined resonance frequency f3.

It is also possible to take the configuration as shown in the second application example of FIG. 9B. In this example, one power receiving space A is formed by a pair of the power transmission coil 20 and the auxiliary coil 21. And followed by a long space B, a power receiving space C is formed by a pair of the power transmission coil 22 and the auxiliary coil 23. In this case, the space B is not used as a power receiving space because of the long distance between the power receiving space A and the power receiving space C. That is, when the power receiving coil 24 enters the space B, the power transmission coil 20 and the auxiliary coil 21 of the power receiving space A are both turned off, and the power transmission coil 22 is kept turned off. Then, when the power receiving coil 24 enters the power receiving space C, the power transmission coil 22 and the auxiliary coil 23 are turned on, performing power transfer.

In the third application example shown in FIG. 9C, the power transmission coils 20, 22 and the auxiliary coils 21, 23, 28 are arranged inside the charging tunnel 19 in alternate order such that they are spaced almost evenly to form the power receiving spaces A, B, C and D. The vehicle 25 equipped with the power receiving coil 24 and the vehicle 27 equipped with the power receiving coil 26 travel through this charging tunnel 19, for example. When the total number of the power transmission coils and the auxiliary coils is an odd number as in this case, the number of the auxiliary coils is set to be larger than that of the power transmission coils by 1, and the power transmission coils and the auxiliary coils are arranged in alternate order. As a result, an even number of power receiving spaces are formed. Further, once an adjustment is made by arranging the auxiliary coil 21 as the first coil at the entrance of the charging tunnel 19, almost no adjustment will be needed thereafter, so that no circuitry for the power system or the control system is needed. Thus, there is an advantage that the cost of the wireless power transfer system as a whole can be reduced.

In order to reduce the influence of adjacent power receiving spaces, in, for example, the power receiving space B adjacent to the power receiving space A where the power receiving coil 24 is located, the other power receiving coil 26 is preferably not located at the same time. A plurality of power receivers may be placed in one power receiving space as needed. In this case, it is necessary to determine the resonance frequency f3 of each auxiliary resonator in advance in accordance with the number of the power receiving coils.

In the configurations of FIGS. 9A to 9C, toy cars are used as the power receivers as an example. In the case of applying these configurations to actual automobiles, the power receivers (vehicles) except the power receiving coils are preferably surrounded by a magnetic shielding material when performing power transfer, from the viewpoint of protection of human body because there are people in the power receivers (in the vehicle).

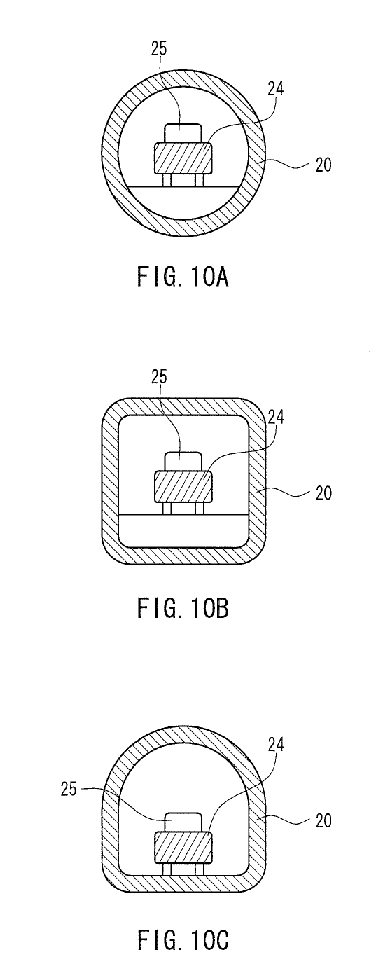

FIGS. 10A to 10C show examples of the cross-sectional shape of the power transmission coil 20 in the direction perpendicular to the traveling direction of the power receiving coils 24, 26 in the above-described configurations. The drawings are schematic diagrams showing the inside of the charging tunnel 19 from the power transmission coil 20 side in FIG. 9A. FIG. 10A shows an example where the power transmission coil 20 has a circular cross section. FIG. 10B is a schematic diagram showing an example where the power transmission coil 20 has a rectangular cross section. FIG. 10C is a schematic diagram showing an example where the power transmission coil 20 has a semicircular cross section. Here, the power transmission coil 20 is placed on the ground. In this way, the shapes of the power transmission coils and the auxiliary coils can be changed depending on the purpose.

Power obtained through the power receiving coil can be used to charge a rechargeable battery or can be transferred directly to a load such as a motor.

### Embodiment 3

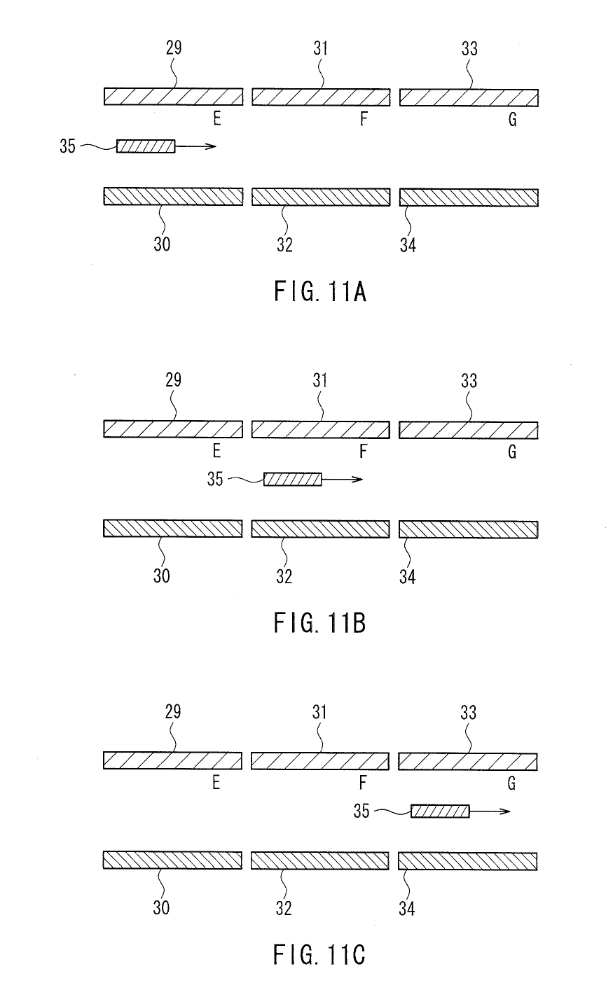

The basic configuration of a wireless power transfer system according to Embodiment 3 will be described with reference to FIGS. 11A to 11C. FIGS. 11A to 11C are schematic cross-sectional views showing the configuration and operation of the wireless power transfer system according to the present embodiment. From FIG. 11A to FIG. 11C show an exemplary operation in which a power receiver travels in one direction.

In the configuration of FIGS. 11A to 11C, a power transmission coil 29 and an auxiliary coil 30, a power transmission coil 31 and an auxiliary coil 32, and a power transmission coil 33 and an auxiliary coil 34 are in pairs, opposing each other, and the pairs form three power receiving spaces E to G. That is, one power receiving space is formed by a pair of opposing power transmission and auxiliary coils and the power receiving spaces E to G are arranged in sequence in the direction perpendicular to the axis of each power transmission coil.

In the power receiving spaces E to G, the axes of the power transmission coils 29, 31, 33 and the auxiliary coils 30, 32, 34 are parallel to each other. A power receiving coil 35 travels in the direction perpendicular to the axial direction of each of the power transmission coils 29, 31, 33 while maintaining its posture such that an axis thereof is parallel to those of the power transmission coils 29, 31, 33. Further, in this example, the central axis of the power transmission coil 29 and that of the auxiliary coil 30 are concentric, and the power transmission coil 29 and the auxiliary coil 30 have the same size in the traveling direction of the power receiving coil 35.

Next, how the operation of each of the power transmission coils 29, 31, 33 and the auxiliary coils 30, 32, 34 is controlled when the power receiving coil 35 travels inside the power receiving spaces will be described. First, it is basic that the power transmission coils and the auxiliary coils of all of the power receiving spaces in which the power receiving coil 35 is absent are turned off (e.g., electrically open).

When the power receiving coil 35 enters the power receiving space E as shown in FIG. 11A, the power transmission coil 29 and the auxiliary coil 30 are turned on (e.g., electrically conducting). As a result, a high frequency power driver of a power transmitter starts transferring power through the power transmission coil 29. In this case, since the resonance frequency f3 of the auxiliary resonator has been adjusted in advance in a state where the power receiving coil 35 is present, power can be transferred stably at any position within the power receiving space E.

Next, when the power receiving coil 35 enters the power receiving space F as shown in FIG. 11B after passing through the power receiving space E, the power transmission coil 29 and the auxiliary coil 30 of the power receiving space E are turned off and at the same time the power transmission coil 31 and the auxiliary coil 32 of the power receiving space F are turned on. As a result, power transfer from the power transmission coil 31 to the power receiving coil 35 starts. Similarly, when the power receiving coil 35 enters the power receiving space G as shown in FIG. 11C, the power transmission coil 31 and the auxiliary coil 32 of the power receiving space F are turned off and at the same time the power transmission coil 33 and the auxiliary coil 34 of the power receiving space G are turned on. Consequently, power transfer from the power transmission coil 33 to the power receiving coil 35 starts. Then, when the power receiving coil 35 exits the power receiving space G, the power transmission coil 33 and the auxiliary coil 34 are turned off, and power transfer to the power receiving coil 35 stops.

In this way, by placing only one power receiver in one power receiving space and using one pair of power transmission and auxiliary coils to transfer power to one power receiving coil, the control system can be simplified. In this case, in each power receiving space, the resonance frequency f3 of each auxiliary resonator is set such that the resonance frequency ft of the power transmission-side resonant system composed of the power transmission resonator and the auxiliary resonator coincides with the resonant frequency f2 of the power receiving resonator. Alternatively, the resonant frequency f3 of the auxiliary resonator can be set by providing the power transmission auxiliary device with an adjusting variable capacitor as a resonant capacitance, and adjusting the adjusting variable capacitor.

The present embodiment is different from Embodiment 2 in that power transmission and auxiliary coils are turned on or off at the same time when the power receiving coil 35 travels through the power receiving spaces E to G. Moreover, it is desirable that power can be supplied only to the power receiving space in which the power receiving coil 35 is present by monitoring the position of the power receiving coil 35. Specifically, each of the power transmission coils or each of the auxiliary coils is provided with a position sensor to detect the comings and goings of the power receiving coil.

Further, in order to prevent magnetic fields of a power receiving space in which the power receiving coil 35 is present from being affected by adjacent power transmission and auxiliary coils, it is preferable that the power transmission coils 29, 31, 33 or the auxiliary coils 30, 32, 34 of the power receiving spaces E to G without the power receiving coil 35 are electrically opened. Alternatively, the resonant capacity used in the auxiliary resonator may be switched depending on the presence or absence of the power receiving coil 35. The system is configured in this way to allow optimum power transfer. When the resonant capacity is switched, f3 of the auxiliary coil of the power receiving space without the power receiving coil 35 is different from f3 of the auxiliary resonator of the power receiving space with the power receiving coil 35.

Further, as in the present embodiment, by arranging power transmission and auxiliary coils such that their central axes are concentric and configuring the power transmission and auxiliary coils to have the same size in the traveling direction of the power receiving coil, the power receiving spaces E, F, G become equal in width. Such a configuration is preferable because the resonance frequency f3 of the auxiliary resonator of each power receiving space can be controlled with ease.

It is preferable that the power transmission coils 29, 31, 33 and the auxiliary coils 30, 32, 34 used in the present embodiment have a size larger in the traveling direction of the power receiving coil 35 than in the direction perpendicular to the traveling direction of the power receiving coil 35. As a result, it is possible to increase in length the space areas in which power can be transferred uniformly. Although the power transmission coils, the auxiliary coils and the power receiving coil are preferably rectangular in shape, similar effect can be achieved even if they have a shape other than rectangular.

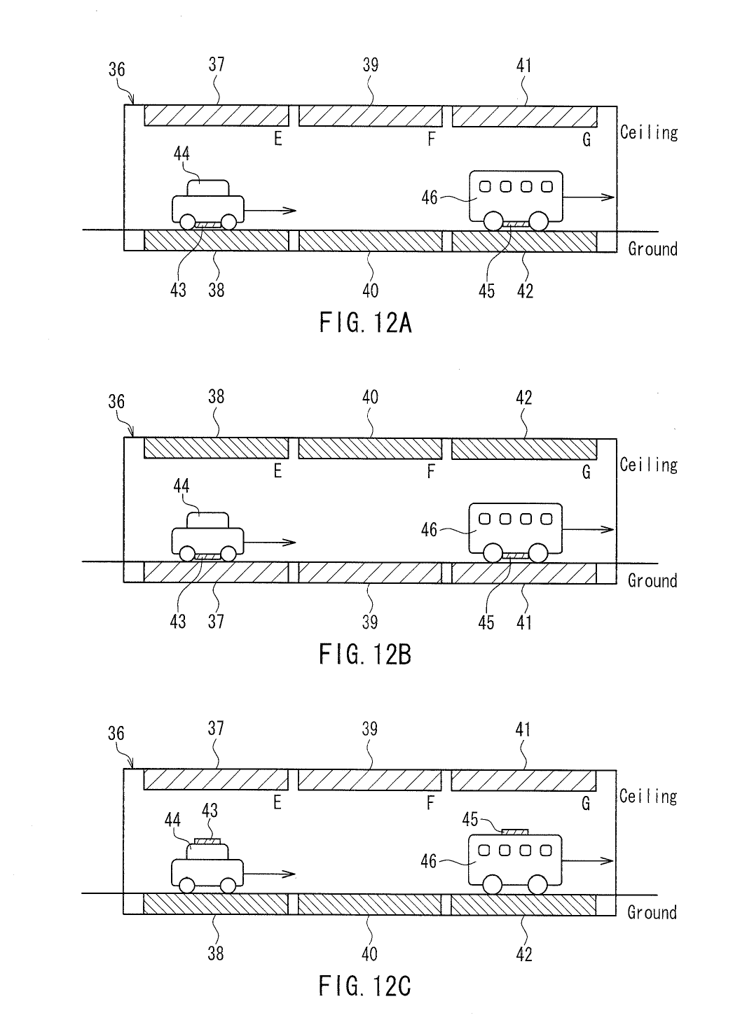

FIGS. 12A to 12C are schematic cross-sectional views showing first to third examples of applying the configuration of the present embodiment to a case where a vehicle equipped with a power receiving coil travels in one direction. Here, it is assumed that the vehicle is a toy racing car.

In the configuration of the first application example of FIG. 12A, a power transmission coil and an auxiliary coils form a pair and they oppose each other to form one power receiving space inside a charging tunnel 36, as in the example of FIG. 11A. Three such power receiving spaces E to G are arranged in sequence in the direction perpendicular to the axes of the power transmission coils 37, 39, 41. That is, the power transmission coils 37, 39, 41 are placed on the ceiling side and the auxiliary coils 38, 40, 42 are placed on the ground side, and the pairs form the power receiving spaces E to G. And a vehicle 44 equipped with a power receiving coil 43 and a vehicle 46 equipped with a power receiving coil 45 travel therethrough.

The power receiving coil 45 of the vehicle 46 is more distant from the auxiliary coils 38, 40, 42 on the ground side than the power receiving coil 43 of the vehicle 44. In either case, it is important that the power receiving coils 43, 45 are mounted such that axes thereof are parallel to those of the power transmission coils and the auxiliary coils so as to improve the transfer efficiency.

In order to reduce the influence of adjacent power receiving spaces, in, for example, the power receiving space F adjacent to the power receiving space E with the power receiving coil 43 located, the other power receiving coil 45 is preferably not located at the same time. However, as needed, the power receiving coils may be in adjacent power receiving areas (e.g., the power receiving areas F and G) at the same time. In this case, it is necessary to carry out such control as switching the capacitors of both the auxiliary coils 40, 42 such that the auxiliary resonators have a predetermined resonance frequency f3.

The second application example of FIG. 12B is an example in which the configuration of FIG. 12A is changed to provide the auxiliary coils 38, 40, 42 on the ceiling side and the power transmission coils 37, 39, 41 on the ground side. As in the example of FIG. 12A, the power receiving coils 43, 45 of the vehicles 44, 46 are provided on the lower side. In the third application example of FIG. 12C, the power transmission coils 37, 39, 41 are provided on the ceiling side and the auxiliary coils 38, 40, 42 are provided on the ground side as in the example of FIG. 12A. The power receiving coils 43, 45 of the vehicles 44, 46 are provided on the top side.

In the present embodiment, the power transmission coils 37, 41 and the auxiliary coils 38, 42 of the power receiving spaces with the power receiving coils 43, 45 (corresponding to the power receiving spaces E and G in FIG. 12A) are turned on and the power transmission coil 39 and the auxiliary coil 40 of the power receiving space without any power receiving coil (corresponding to the power receiving space F in FIG. 12A) are turned off. The way to switch the power transmission and auxiliary coils between on and off when the power receiving coils 43, 45 travel is the same as that explained above in connection with the configuration shown in FIG. 11A.

A plurality of power receivers may be placed in one power receiving space as needed. In this case, however, it is necessary to determine the resonance frequency f3 of each auxiliary resonator in advance in accordance with the number of the power receiving coils.

In order to reduce the influence of adjacent power receiving spaces, in, for example, the power receiving space F adjacent to the power receiving space E with the power receiving coil 43 located, the other power receiving coil 45 is preferably not located at the same time. In the present embodiment, toy cars are used as power receivers as an example. In the case of applying this to actual automobiles, the power receivers (vehicles) except the power receiving coils are preferably surrounded by a magnetic shielding material when performing power transfer from the viewpoint of protection of human body because there are people in the power receivers (vehicles).

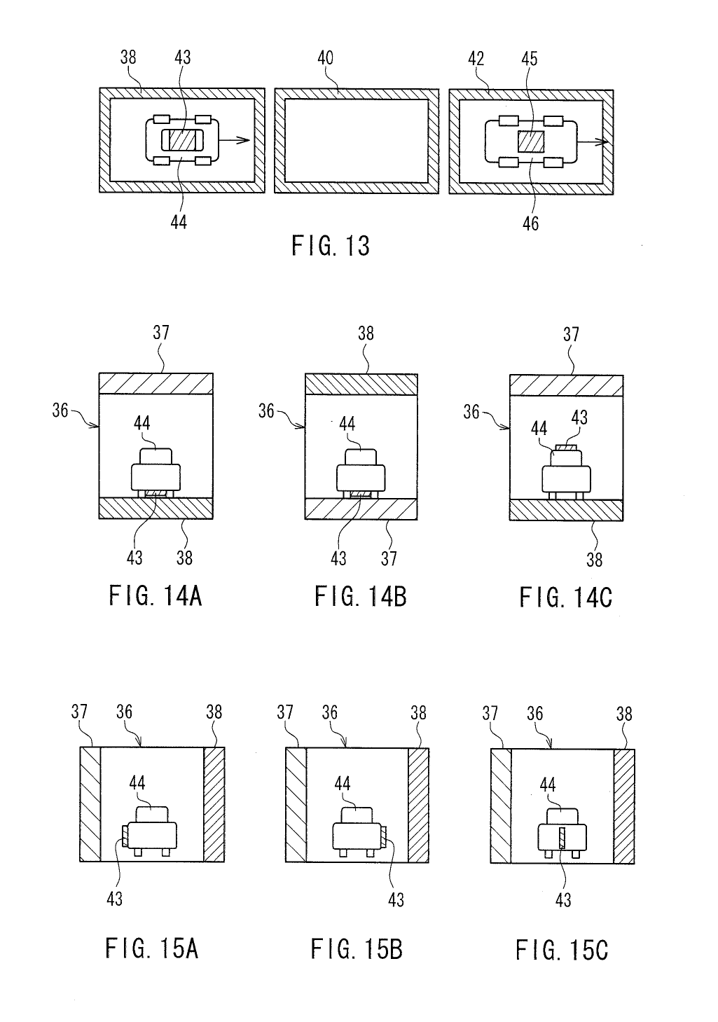

FIG. 13 is an exemplary view of the configuration shown in FIG. 12C from the power transmission coils 37, 39, 41 arranged on the ceiling of the charging tunnel 36 to the auxiliary coils 38, 40, 42. The auxiliary coils 38, 40, 42 are rectangular air-core coils (however, the core area having no coil wire is not a space with a through hole as in FIG. 9A). The auxiliary coils 38, 40, 42 are longer in the traveling direction of the power receiving coils 43, 45 than in the direction perpendicular to the traveling direction of the power receiving coils 43, 45. As a result, power can be transferred for a long time. The corresponding power transmission coils also have a shape similar to that of the auxiliary coils 38, 40, 42.

FIG. 14A to 14C are schematic diagrams showing examples of the structures shown in FIG. 12A to 12C, respectively, where the structures are seen from the entrance side of the charging tunnel 36. The entrance of the charging tunnel 36 is rectangular and the power transmission coils 37, 39, 41 and the auxiliary coils 38, 40, 42 are provided on the ceiling side and the ground side, respectively, and vice versa. The arrangements correspond to FIG. 12A to 12C, respectively.

The power receiving coil 43 can be mounted on the top side or the lower side of the vehicle, and may be mounted such that the axis thereof is parallel to those of the power transmission coils and the auxiliary coils so as to enhance the transfer efficiency.

In contrast to the above-described configuration, FIGS. 15A to 15C show examples of arranging the power transmission coils 37, 39, 41 and the auxiliary coils 38, 40, 42 on not the top and lower sides but on the left and right sides of the charging tunnel 36. In these schematic views, the rear end of the vehicle seen from the entrance side of the charging tunnel 36 is shown.

The power receiving coil 43 can be mounted on the right or left side of the vehicle 44. As needed, the power receiving coil 43 can also be provided at the center part of the vehicle as shown in FIG. 15C. That is, the power receiving coil 43 may be mounted such that the axis thereof is parallel to those of the power transmission coils 37, 39, 41 and the auxiliary coils 38, 40, 42.

The power obtained through the power receiving coil can be used to charge a rechargeable battery or can be directly transferred to a load such as a motor.

### Embodiment 4

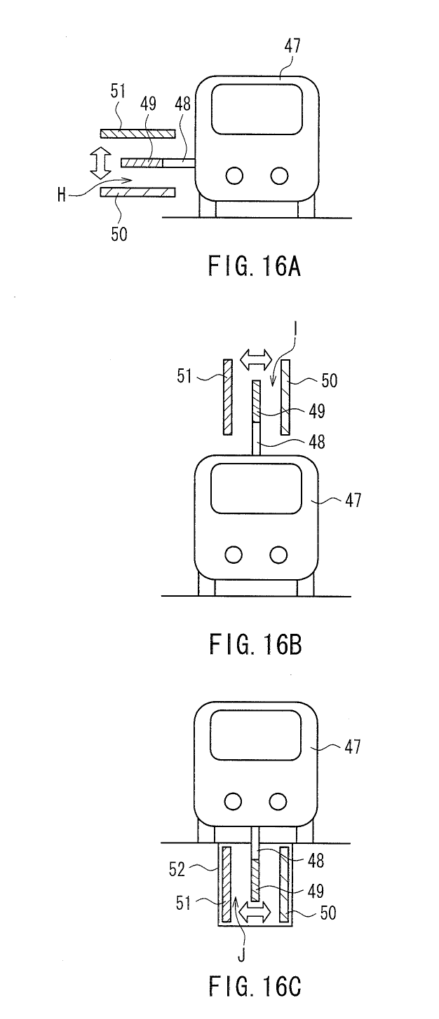

The configuration of a wireless power transfer system according to Embodiment 4 will be described with reference to FIGS. 16A to 16C. FIGS. 16A to 16C are plan views schematically showing the configuration and operation of the wireless power transfer system according to the present embodiment. FIG. 16A to 16C show configuration examples different from each other.

In the present embodiment, a power receiving coil is placed alone in a power receiving space. That is, in Embodiments 2 and 3, an entire power receiver including a power receiving coil is placed between power transmission and auxiliary coils to transfer power. In contrast, in the present embodiment, in order to reduce the impact on human bodies, a power receiving coil is placed alone between power transmission and auxiliary coils to transfer power. The embodiment will be described by taking as an example a rotary bus whose traffic route is substantially fixed.

In the configuration of FIG. 16A, a coil supporting member 48 protrudes horizontally from a side of a bus 47, and a power receiving coil 49 is supported by the coil supporting member 48. The coil supporting member 48 and the power receiving coil 49 are configured to protrude externally from the bus 47 only during power transfer. On one side with respect to the bus 47, a power transmission coil 50 and an auxiliary coil 51 are arranged vertically to oppose each other and they form a power receiving space H. Power transfer is performed while the power receiving coil 49 travels inside the power receiving space H (in the drawing, the power receiving coil travels toward the front of the sheet). In the power receiving space H, the power transfer efficiency hardly varies even if the power receiving coil 49 is swayed vertically and horizontally during the travel.

In the configuration of FIG. 16B, the coil supporting member 48 protrudes upwardly from the top of the bus 47, and the power receiving coil 49 is supported by the coil supporting member 48. The power receiving coil 49 and the like can be configured to protrude externally from the bus 47 only during power transfer. Above the bus 47, the power transmission coil 50 and the auxiliary coil 51 are arranged horizontally to oppose each other and they form a power receiving space I. Power transfer is performed while the power receiving coil 49 travels inside the power receiving space I (in the drawing, the power receiving coil travels toward the front of the sheet). In the power receiving space I, the power transfer efficiency hardly varies even if the power receiving coil 49 is swayed vertically and horizontally during the travel.

In the configuration of FIG. 16C, the coil supporting member 48 protrudes downwardly from the lower side of the bus 47, and the power receiving coil 49 is supported by the coil supporting member 48. The power receiving coil 49 and the like are configured to protrude externally from the bus 47 only during power transfer. A power supply box 52 is imbedded in the ground below the bus 47. And in the power supply box 52, the power transmission coil 50 and the auxiliary coil 51 are arranged horizontally to oppose each other and they form a power receiving space J. Power transfer is performed while the power receiving coil 49 travels inside the power receiving space J (in the drawing, the power receiving coil travels toward the front of the sheet). In the power receiving space J, the power transfer efficiency hardly varies even if the power receiving coil 49 is swayed vertically and horizontally during the travel.

In the present embodiment, the way to switch the power transmission coil 50 and the auxiliary coil 51 between on and off when the power receiving coil 49 travels is substantially the same as that explained above in Embodiment 3 in connection with the configuration shown in FIG. 11A. Further, since magnetic fields are applied only to the power receiving coil 49 during power transfer, people taking the bus 47 are not adversely affected, so that this is preferable also from the viewpoint of protection of human body. However, it is more preferable that the power transmission coil 50, the auxiliary coil 51 and the power receiving coil 49 are surrounded by a magnetic shielding material. The present embodiment can be applied not only to rotary buses but also to electric vehicles and trains (i.e., it can be an alternative to a pantograph).

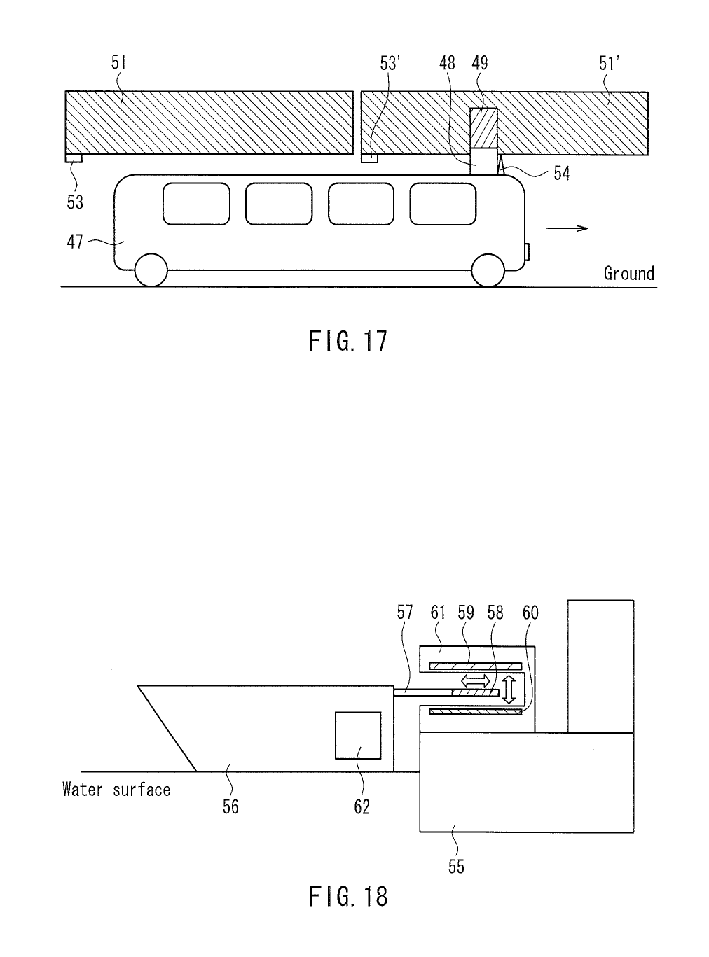

As in the configuration of Embodiment 3, e.g., the one shown in FIG. 12A, in the present embodiment, a plurality of power receiving spaces, which are formed by arranging power transmission coils and auxiliary coils to form a plurality of pairs and to oppose each other, can also be arranged in the direction perpendicular to the axis of the power transmission coil 50. FIG. 17 shows an example of applying such a configuration to the system shown in FIG. 16B. FIG. 17 is a schematic side view of the system shown in FIG. 16B and shows a state where the bus 47 travels from the left to the right of the drawing.

In the bus 47 shown in FIG. 17, the coil supporting member 48 protrudes upwardly from the front end portion, and the power receiving coil 49 is supported by the coil supporting member 48. The power receiving coil 49 and the like can be configured to protrude externally from the bus 47 only during power transfer.

Above the bus 47, power transmission coils (not shown) and auxiliary coils 51, 51′ are arranged to oppose each other and the pairs form power receiving spaces. Vehicle position monitoring sensors 53, 53′ are provided on the power transmission coils or the auxiliary coils 51, 51′, respectively, on one side. A vehicle position transmitter 54 is provided on the front-end side of the power receiving coil 49. The position of the power receiving coil 49, the positions of the vehicle position monitoring sensors 53, 53′ and the position of the vehicle position transmitter 54 can be set appropriately on a case-by-case basis.

A specific example of operation by this configuration is as follows. When the vehicle position transmitter 54 provided on the front-end part of the bus 47 passes through the vehicle position monitoring sensor 53 provided on the auxiliary coil 51, the auxiliary coil 51 and a power transmission coil opposing the auxiliary coil 51 are both turned on and power transfer to the power receiving coil 49 starts. Next, when the vehicle position transmitter 54 passes through the vehicle position monitoring sensor 53′ provided on the auxiliary coil 51′, the auxiliary coil 51 and the power transmission coil opposing the auxiliary coil 51 are both turned off. At the same time, the auxiliary coil 51′ and a power transmission coil opposing the auxiliary coil 51′ are both turned on and power transfer to the power receiving coil 49 starts. Power transfer is performed continuously by repeating such operations while the power receiving coil travels in one direction.

Power obtained through the power receiving coil can be stored in a rechargeable battery or can be transferred directly to a load such as a motor.

### Embodiment 5

The configuration of a wireless power transfer system according to Embodiment 5 will be described with reference to FIG. 18. FIG. 18 is a schematic cross-sectional view showing the configuration of the wireless power transfer system according to the present embodiment. The present embodiment relates to an application example where power is transferred to a fishing vessel, a boat, etc. at a port dock.

FIG. 18 shows a boat 56 moored to a dock 55. A coil supporting member 57 protrudes in a rear direction from the rear end of the boat, and a power receiving coil 58 is supported by the coil supporting member 57. The power receiving coil 58 and the like can be configured to protrude externally from the boat 56 only during power transfer. A power supply box 61 is placed at the dock 55. In the power supply box 61, a power transmission coil 59 and an auxiliary coil 60 are arranged to oppose each other and they form a power receiving space.

To perform power transfer, the power receiving coil 58 is placed into the power receiving space in the power supply box 61. Although the power receiving coil 58 is swayed vertically and horizontally by waves during power transfer, power can be transferred stably inside this power receiving space. And the power obtained is used to charge a rechargeable battery 62 provided in the boat 56.

In place of fixing the power supply box 61 to the dock, the power supply box 61 may be mounted on a vessel much larger than the boat 56 and power supply to the boat 56 may be performed at sea. As a still another example, the power supply box 61 and the power receiving coil 58 may be placed in the water and power transfer may be performed while both of them are being swayed. The wireless charging system of a resonant type is also characterized in that it can be used even in the water.

### Embodiment 6

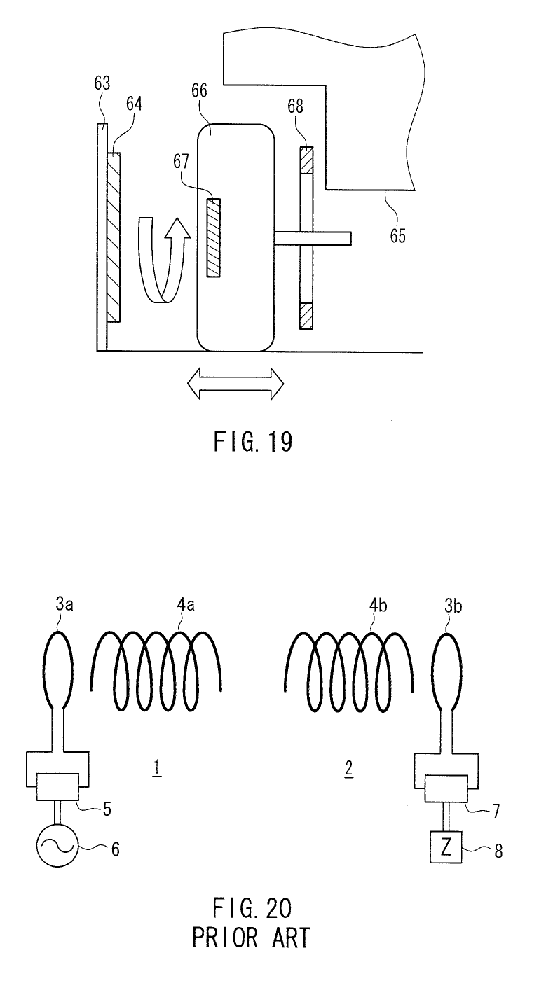

The configuration of a wireless power transfer system according to Embodiment 6 will be described with reference to FIG. 19. FIG. 19 is a schematic cross-sectional view showing the configuration of the wireless power transfer system according to the present embodiment. The present embodiment relates to an application example where power is transferred to a trolley bus while a power receiving coil is being rotated.

FIG. 19 shows a state where a power transmission coil 64 is fixed to a power transmission coil mounting wall 63 on the road side, and a vehicle 65 runs along the power transfer coil mounting wall 63. A power receiving coil 67 is incorporated in a tire 66 of the vehicle 65. An auxiliary coil 68 is fixed to the body of the vehicle 65 so as to oppose the power receiving coil 67. A structure for supporting the tire 66 and the auxiliary coil 68 by the body of the vehicle 65 is not illustrated because a typical supporting structure can be used.

The power transmission coil 64 is rectangular and extends along the road for a long distance. The center position of the power transmission coil 64 from the ground is set to substantially the same height as that of the power receiving coil 67 incorporated in the tire 66. The power receiving coil 67 may be in the tire 66 or may be mounted on a portion outside the tire, such as a wheel base.

In the present embodiment, the power receiving space is formed between the power transmission coil 64 fixed to the power transfer coil mounting wall 63 and the auxiliary coil 68 supported by the body of the vehicle 65. Power is transferred from the power transmission coil 64 while the power receiving coil 67 rotates and travels along the road with the travel of the vehicle 65. The power receiving space at the time of power transfer has the same size as the area determined by the coil surface of the auxiliary coil 68.

As another example, a power receiving coil only rotates and does not travel with respect to a power transmission coil. Even in such a case, similar effects can be achieved.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A wireless power transfer system comprising:
a power transmitter including a power transmission resonator composed of a power transmission coil and a resonant capacitance; and
a power receiver including a power receiving resonator composed of a power receiving coil and a resonant capacitance,
thereby transferring power from the power transmitter to the power receiver through an interaction between the power transmission coil and the power receiving coil,
wherein the wireless power transfer system further comprises a power transmission auxiliary device including an auxiliary resonator composed of an auxiliary coil and a resonant capacitance,
the power transmission auxiliary device and the power transmission device are arranged so as to oppose each other, forming a power receiving space for placing the power receiving coil between the power transmission coil and the auxiliary coil, and
power transfer is performed in the power receiving space while involving a movement of the power receiving coil including at least one of a displacement and a rotation.

2. The wireless power transfer system according to claim 1, wherein power is transferred from the power transmitter to the power receiver through magnetic field resonance between the power transmission coil and the power receiving coil.

3. The wireless power transfer system according to claim 1, wherein when the power receiving coil is placed in the power receiving space, axes of the power transmission coil, the auxiliary coil, and the power receiving coil are parallel to each other.

4. The wireless power transfer system according to claim 1, wherein the power receiving coil travels in one direction inside the power receiving space.

5. The wireless power transfer system according to claim 1, wherein power transfer is performed while involving a rotation and travel of the power receiving coil.

6. The wireless power transfer system according to claim 1, wherein the power receiving coil is placed alone in the power receiving space.

7. The wireless power transfer system according to claim 6, wherein only one pair of the power transmission coil and the auxiliary coil is used to transfer power to the power receiving coil.

8. The wireless power transfer system according to claim 7, wherein a resonant frequency f1 of the power transmission resonator, a resonant frequency f2 of the power receiving resonator, and a resonant frequency f3 of the auxiliary resonator are set to satisfy the relationship f1=f2<f3 or f3<f1=f2.

9. The wireless power transfer system according to claim 7, wherein a resonant frequency f1 of the power transmission resonator, a resonant frequency f2 of the power receiving resonator, and a resonant frequency f3 of the auxiliary resonator are set to satisfy the relationship f2<f1=f3 or f1=f3<f2.

10. The wireless power transfer system according to claim 7, wherein a diameter d1 of the power transmission coil, a diameter d2 of the power receiving coil, and a diameter d3 of the auxiliary coil satisfy the relationship d1>d2 and d2<d3.

11. The wireless power transfer system according to claim 10, wherein d1, d2 and d3 satisfy the relationship d1=d3 and d1>d2.

12. The wireless power transfer system according to claim 1, wherein at least one of the power transmission coil and the auxiliary coil is an air-core coil, and a through hole large enough to allow the power receiver to pass therethrough is formed in the air-core coil at a core part.

13. The wireless power transfer system according to claim 12, wherein the power receiving coil travels through at least one of the power transmission coil and the auxiliary coil.

14. The wireless power transfer system according to claim 1, wherein power transfer is performed in a state where the power receiver except the power receiving coil is entirely surrounded by a magnetic shielding material.

15. The wireless power transfer system according to claim 1, wherein a plurality of the power receiving spaces are formed.

16. The wireless power transfer system according to claim 15, wherein the power receiving spaces are arranged in one direction.

17. The wireless power transfer system according to claim 15, wherein in the power receiving space adjacent to the power receiving space in which the power receiving coil is located, another power receiving coil is not placed at the same time.

18. The wireless power transfer system according to claim 15, wherein a position of the power receiving coil is monitored to supply power only to the power receiving space in which the power receiving coil is located.

19. The wireless power transfer system according to claim 18, wherein at least one of the power transmission coil and the auxiliary coil forming the power receiving space in which the power receiving coil is not located is electrically opened.

20. The wireless power transfer system according to claim 15, wherein the resonant capacitance used in the auxiliary resonator of the power receiving space in which the power receiving coil is placed is varied from that of the auxiliary resonator of the power receiving space in which the power receiving coil is not placed.

21. The wireless power transfer system according to claim 15, wherein a resonant frequency of the auxiliary resonator of the power receiving space in which the power receiving coil is placed is varied from that of the auxiliary resonator of the power receiving space in which the power receiving coil is not placed.

22. The wireless power transfer system according to claim 15, wherein all of the power transmission coils and the auxiliary coils are arranged such that their central axes are concentric.

23. The wireless power transfer system according to claim 22, wherein the power transmission coils and the auxiliary coils are arranged in alternate order in the arrangement direction of the power receiving spaces.

24. The wireless power transfer system according to claim 23, wherein the power transmission coils and the auxiliary coils are spaced evenly.

25. The wireless power transfer system according to claim 15, wherein in each of the power receiving spaces, the power transmitting coil and the auxiliary coil forming a pair are arranged to oppose each other in a direction perpendicular to the arrangement direction of the power receiving spaces.

26. A wireless power transmission method using: a power transmitter including a power transmission resonator composed of a power transmission coil and a resonant capacitance; and
a power receiver including a power receiving resonator composed of a power receiving coil and a resonant capacitance,
thereby transferring power from the power transmitter to the power receiver through an interaction between the power transmission coil and the power receiving coil,
wherein the method further uses a power transmission auxiliary device including an auxiliary resonator composed of an auxiliary coil and a resonant capacitance,
a power receiving space for placing the power receiving coil is formed between the power transmission coil and the auxiliary coil by arranging the power transmission auxiliary device and the power transmission device to oppose each other, and
power transfer is performed in the power receiving space while involving a movement of the power receiving coil including at least one of a displacement and a rotation.
